(19) United States
(12) Patent Application Publication
(10) Pub. No.: US 2019/0077134 A1
(43) Pub. Date: Mar. 14, 2019

(54) DECORATIVE FILM AND METHOD FOR PRODUCING SAME, AND DECORATED MOLDED ARTICLE

(71) Applicants: TOYO INK SC HOLDINGS CO., LTD., Tokyo (JP); TOYOCHEM CO., LTD., Tokyo (JP)

(72) Inventors: Takahiro KONNO, Tokyo (JP); Mitsuo UMEZAWA, Tokyo (JP)

(73) Assignees: TOYO INK SC HOLDINGS CO., LTD., Tokyo (JP); TOYOCHEM CO., LTD., Tokyo (JP)

(21) Appl. No.: 15/762,558

(22) PCT Filed: Sep. 23, 2016
(86) PCT No.: PCT/JP2016/004318

§ 371 Date: Mar. 23, 2018

(30) Foreign Application Priority Data
Sep. 25, 2015 (JP) 2015-188517
Sep. 25, 2015 (JP) 2015-188518
Sep. 25, 2015 (JP) 2015-188519
Sep. 25, 2015 (JP) 2015-188520
Nov. 27, 2015 (JP) 2015-231528
Nov. 27, 2015 (JP) 2015-232070
Dec. 22, 2015 (JP) 2015-249283
Mar. 31, 2016 (JP) 2016-072336
Aug. 10, 2016 (JP) 2016-158117

(51) Int. Cl. B32B 27/30; B32B 27/26; B32B 7/12; B32B 7/06; B32B 27/36

(52) U.S. Cl. CPC B32B 27/30; B32B 27/26; B32B 7/12; B32B 7/06; B32B 2451/00; B32B 2307/54; B32B 2307/40; B32B 2305/72; B32B 27/365

(57) ABSTRACT

A decorative film according to the present disclosure comprises a laminate comprising a hard coat layer and a base material layer. The hard coat layer consists of a cured product of a thermosetting coating material comprising an acrylic copolymer (A) having hydroxy groups and an isocyanate curing agent (B). The hard coat layer has a predetermined total light transmittance, diffuse transmittance and tensile strength. The acrylic copolymer (A) has a specific hydroxy value, acid value, glass transition temperature, Mw and Mw/Mn and is a copolymer having units derived from monomers having hydroxy group(s). The content percentage of a unit derived from a monomer having one hydroxy group in 100% by mol of the units derived from monomers having hydroxy group(s) and the content percentage of a primary hydroxy group in the acrylic copolymer (A) satisfy specific ranges.

### TECHNICAL FIELD

The present disclosure relates to a decorative film having a hard coat layer formed from a specific acrylic coating material on the surface and a method for producing the same. The present disclosure also relates to a decorated molded article in which the surface is covered with the decorative film, and the hard coat layer is laterally placed.

### BACKGROUND ART

Resin molded products are often used in portable information terminal equipment such as smartphones, notebook computers, home electrical appliances, automobile interior and exterior parts, and the like. These resin molded products are usually decorated on their surfaces by painting, printing, or the like after molding of plastic resins in order to enhance their design.

Heretofore, the surfaces of the resin molded products have been painted with coloring coating materials or printed in order to confer design. Also, the surfaces of the resin molded products have been spray-painted or dip-painted with hard coat coating materials for surface protection. However, such conventional decoration methods have the difficulty in performing decoration with high design. For reasons such as disadvantages in productivity, methods for decorating the surfaces of resin molded products using decorative films have become widespread as substitutes therefor. The decorative film refers to a film having a pattern or hard coat layer disposed on a base material film by printing or application.

The methods using the decorative film include, for example, (1) a method which involves providing a preliminarily obtained resin molded product to be decorated and laminating the decorative film on the surface of the resin molded product, and (2) a method which involves injecting a resin for injection molding to be decorated to the decorative film loaded in a die and integrating the resin molded product with the decorative film. The method (2) may involve premolding the decorative film prior to the injection of the resin for injection molding. Examples of means for the premolding include vacuum molding as well as mechanical molding.

The utilization of the decorative film in various ways has been proposed in Patent Literatures 1 to 8. Patent Literature 1 describes a multilayered body in which a layer consisting of an acrylic resin (A) and a layer consisting of an aliphatic polycarbonate resin (B) are laminated. The literature states that a multilayered body excellent in transparency, heat resistance, shock resistance, UV discoloration resistance, and surface hardness is obtained by use of the aliphatic polycarbonate resin (B) having a specific structure.

Patent Literature 2 discloses, as a chip-proof and easy-to-mold resin film having excellent whitening resistance and a high surface hardness, a multilayer film in which a layer (B) of a methacrylic resin material containing 85 to 100 parts by mass of a methacrylic resin and 0 to 15 parts by mass of acrylic rubber particles is laminated on at least one side of a layer (A) of a polycarbonate resin material, wherein the glass transition temperature of the methacrylic resin is in a predetermined relationship with the glass transition temperature of the polycarbonate resin material. The literature also discloses that the multilayer film is suitably used as a surface decorative film for exterior members of home electrical appliances, automobile interior members, and the like. The literature suggests that a methyl methacrylate polymer is suitable as the methacrylic resin.

Patent Literature 3 discloses a method for producing a decorated molded product using an ink composition for hard coat layers having ionizing radiation curability, comprising:

(1) a step of placing a decorative sheet having at least a release layer and a hard coat layer-forming layer coated with the ink composition for hard coat layers having ionizing radiation curability in this order on one side of a base material film in an injection molding die;

(2) an injection step of injecting a melted resin into a cavity, followed by cooling and solidification to integrally laminate the resin molded article with the decorative sheet;

(3) a step of retrieving the molded article comprising the resin molded article and the decorative sheet integrated with each other from the die;

(4) a step of stripping the base material film of the decorative sheet from the molded article; and

(5) a hard coat layer formation step of curing the hard coat layer-forming layer disposed on the molded article in an atmosphere having an oxygen concentration of 2% or less.

Patent Literature 4 discloses a curable resin composition intended for films for heat molding, comprising: a vinyl polymer (A) having a carboxyl group and a hydroxy group and having a solid acid value of 15 to 150 mgKOH/g, a solid hydroxy value of 2 to 80 mgKOH/g, and a glass transition temperature of 70 to 140° C.; and a polyisocyanate compound (B), wherein the content of the polyisocyanate compound is a content that permits reaction for the solid hydroxy value of 2 to 80 mgKOH/g of the vinyl polymer(A).

Patent Literature 5 discloses a laminated hard coat film for molding comprising a resin-containing hard coat layer disposed on a base material film, wherein the laminated hard coat film has a rate of elongation of 10% or more in an atmosphere of 23° C. and 50% RH. An active energy beam-curable resin is used as the resin contained in the hard coat layer.

Patent Literature 6 discloses a decorative sheet with a top coat having a top coat layer on one side of a decorative sheet, wherein the top coat layer has a surface hardness equal to or higher than pencil hardness B at −40° C. to 130° C. and a rate of stretching of 150% or more in a tensile tester at 150° C. The top coat layer disclosed therein is prepared by photocuring a resin composition.

Patent Literature 7 describes a transfer film obtained by applying a resin composition onto a strippable gas film, the resin composition containing at least a polymer (A) having a hydroxy group and a carboxyl group, a polyisocyanate (B) and a prepolymer (C) having three or more acryloyl groups or methacryloyl groups in one molecule (Claims 1 and 5). Claim 2 states that the polymer (A) is a polymer obtained by copolymerizing a polymerizable monomer mixture comprising a polymerizable monomer having a hydroxy group and an unsaturated double bond and a polymerizable monomer having a carboxyl group having an unsaturated double bond. Claim 3 states that the polymer (A) has a hydroxy value of 5 to 100 mgKOH/g, a weight-average molecular weight of 30,000 to 300,000, and a glass transition temperature of 60 to 180° C.

Patent Literature 8 discloses an integrally moldable laminated sheet having a cured resin layer as a top coat layer (Claim 1). Claims 2 and 3 state that the cured resin layer as the top coat layer is a resin layer obtained by curing a resin composition consisting of a hydroxy group-containing vinyl copolymer (A) having a hydroxy value of 10 to 300 mgKOH/g, a weight-average molecular weight of 2,000 to 50,000, and a glass transition temperature (Tg) of 80° C. or lower, and a polyisocyanate compound (B).

In addition, Patent Literatures 9 to 12 disclose, albeit inventions relating to solar cell underside protective sheets, not the decorative film, cured coatings prepared by curing an acrylic copolymer with an isocyanate curing agent.

Patent Literature 13 discloses that a blade for wind power generation is covered using a coating material containing an acrylic copolymer and an isocyanate curing agent.

### CITATION LIST

### Patent Literature

### Patent Literature 1: Japanese Unexamined Patent Application Publication No. 2011-161871

### Patent Literature 2: Japanese Unexamined Patent Application Publication No. 2010-125645

### Patent Literature 3: Japanese Unexamined Patent Application Publication No. 2011-161692

### Patent Literature 4: Japanese Unexamined Patent Application Publication No. 2012-097248

### Patent Literature 5: Japanese Unexamined Patent Application Publication No. 2012-210755

### Patent Literature 6: Japanese Unexamined Patent Application Publication No. 2013-006346

### Patent Literature 7: Japanese Unexamined Patent Application Publication No. 2010-126633

### Patent Literature 8: Japanese Unexamined Patent Application Publication No. 2002-347179

### Patent Literature 9: Japanese Unexamined Patent Application Publication No. 2013-051394

### Patent Literature 10: Japanese Unexamined Patent Application Publication No. 2015-008282

### Patent Literature 11: Japanese Unexamined Patent Application Publication No. 2015-166450

### Patent Literature 12: Japanese Unexamined Patent Application Publication No. 2016-027152

### Patent Literature 13: Japanese Patent No. 5910804

### SUMMARY OF INVENTION

### Technical Problem

Decorative films are used in, for example, automobile interior members and therefore required to have excellent design. The decorative films are also required to have excellent moldability that permits three-dimensional molding as well as abrasion resistance. There is also a demand for a highly versatile production method for developing the application of the decorative films to various purposes. For use in, for example, automobile interior members, the decorative films are required to have sunscreen cream resistance.

The techniques of Patent Literatures 1 to 13 described above do not satisfy all of these characteristics.

The present disclosure has been made in light of the background described above. An object of the present disclosure is to provide a decorative film having high versatility, excellent moldability during molding, excellent design, excellent abrasion resistance, and excellent sunscreen cream resistance and a method for producing the same, and a decorated molded article.

### Solution to Problem

[1] A decorative film comprising a laminate comprising a hard coat layer and a base material layer,

wherein the decorative film satisfies the following conditions (I) to (VII):

(I) the hard coat layer is a cured product of a thermosetting coating material comprising an acrylic copolymer (A) having hydroxy groups and an isocyanate curing agent (B);

(II) the hard coat layer has a total light transmittance of 40% or more and a diffuse transmittance of 70% or less;

(III) the hard coat layer has a tensile strength of 15 to 100 N/mm² in an atmosphere of 25° C. and 50% RH;

(IV) the acrylic copolymer (A) has

a hydroxy value of 5 to 210 mgKOH/g, an acid value of 0 to 20 mgKOH/g, a glass transition temperature of 0 to 95° C., a weight-average molecular weight of 100,000 to 1,000,000, and weight-average molecular weight/number-average molecular weight of 2.3 to 10;

(V) the acrylic copolymer (A) is a copolymer consisting of units derived from monomers having hydroxy group(s) and a unit derived from an additional monomer;

(VI) a content percentage of a unit derived from a monomer having one hydroxy group in 100% by mol of the units derived from monomers having hydroxy group(s) is 50% by mol or more; and

(VII) 56% or more of the hydroxy groups in the acrylic copolymer (A) is a primary hydroxy group.

[2] The decorative film according to [1], wherein a ratio of the isocyanate groups in the isocyanate curing agent (B) to the hydroxy groups in the acrylic copolymer (A) having hydroxy groups, NCO/OH, in the coating material is 1/1 to 3/1.
[3] The decorative film according to [1] or [2], wherein the base material layer consists of a single layer or multiple layers of a material selected from the group consisting of polyester, polycarbonate, and polymethyl methacrylate.
[4] The decorative film according to any of [1] to [3], wherein the hard coat layer and the base material layer abut on each other.
[5] The decorative film according to any of [1] to [3], further comprising at least any one of an adhesive layer and a colored layer.
[6] The decorative film according to [5], wherein the adhesive layer is laminated between the base material layer and the hard coat layer.
[7] The decorative film according to [5], wherein the adhesive layer is laminated on a non-facing side of the base material layer with respect to the hard coat layer.
[8] A decorated molded article comprising: a decoratable object; and a decorative film configured to cover at least a portion of the decoratable object, wherein the decorative film comprises a laminate comprising a base material layer and a hard coat layer and is a decorative film according to any of [1] to [6].
[9] A method for producing a decorative film comprising a laminate comprising a hard coat layer and a base material layer, comprising:

providing a thermosetting coating material for forming the hard coat layer, the thermosetting coating material comprising an acrylic copolymer (A) having hydroxy groups and an isocyanate curing agent (B), wherein the hard coat layer which is a cured product of the coating material has a tensile strength of 15 to 100 N/mm² in an atmosphere of 25° C. and 50% RH; and

a step of obtaining a coating layer by coating with the coating material and forming the laminate having a cured coating of the coating layer,

wherein the acrylic copolymer (A) used

is obtained by copolymerizing monomers having hydroxy group(s) with an additional monomer, and is a polymer configured such that a content percentage of a monomer having one hydroxy group in 100% by mol of the monomers having hydroxy group(s) is 50% by mol or more, 56% or more of the hydroxy groups of the acrylic copolymer (A) is a primary hydroxy group, a hydroxy value is 5 to 210 mgKOH/g, an acid value is 0 to 20 mgKOH/g, a glass transition temperature is 0 to 95° C., a weight-average molecular weight is 100,000 to 1,000,000, and weight-average molecular weight/number-average molecular weight is 2.3 to 10.

[10] The method for producing a decorative film according to [9], wherein the step of obtaining a coating layer by coating with the coating material and forming the laminate having a cured coating of the coating layer comprises

a step of coating any layer, other than the hard coat layer, constituting the laminate with the coating material.

[11] The method for producing a decorative film according to [9], wherein the step of obtaining a coating layer by coating with the coating material and forming the laminate having a cured coating of the coating layer comprises

a step of obtaining a coating layer by coating a strippable film with the coating material, obtaining a cured coating of the coating layer, and then joining the cured coating to any layer, other than the hard coat layer, constituting the laminate.

### Advantageous Effects of Invention

The present disclosure exerts an excellent effect of being able to provide a decorative film having high versatility, excellent moldability during molding, excellent design, excellent abrasion resistance, and excellent sunscreen cream resistance and a method for producing the same, and a decorated molded article.

### BRIEF DESCRIPTION OF THE DRAWINGS

FIG. 1 is a schematic cross-sectional view showing a configuration example of the decorative film of the present disclosure;

FIG. 2 is a schematic cross-sectional view showing a configuration example of the decorative film of the present disclosure;

FIG. 3 is a schematic cross-sectional view showing a configuration example of the decorative film of the present disclosure;

FIG. 4 is a schematic cross-sectional view showing a configuration example of the decorative film of the present disclosure;

FIG. 5 is a schematic cross-sectional view showing a configuration example of the decorative film of the present disclosure;

FIG. 6 is a schematic cross-sectional view showing a configuration example of the decorative film of the present disclosure;

FIG. 7 is a schematic cross-sectional view showing a configuration example of the decorative film of the present disclosure; and

FIG. 8 is a schematic cross-sectional view showing a configuration example of the decorative film of the present disclosure.

### DESCRIPTION OF EMBODIMENTS

Hereinafter, examples of embodiments to which the present disclosure is applied will be described. Numerical values defined in the present specification are values that are determined by methods disclosed in the embodiments or Examples. A numerical range of “A to B” defined in the present specification refers to a range that satisfies the numerical value A, a value larger than the numerical value A, the numerical value B, and a value smaller than the numerical value B. The term “film” in the present specification includes not only a “film” defined in JIS but a “sheet”. Various components described in the present specification may be each independently used alone or may be used in combination of two or more, unless otherwise specified. The term “(meth)acrylic” means both acrylic and methacrylic. The term “(meth)acrylate” means both acrylate and methacrylate.

The decorative film of the present embodiment comprises a laminate comprising at least a hard coat layer and a base material layer and satisfies the following conditions (I) to (VII):

(I) the hard coat layer is a cured product of a coating material comprising an acrylic copolymer (A) having hydroxy groups (hereinafter, also simply referred to as an “acrylic copolymer (A)”) and an isocyanate curing agent (B);

(II) the hard coat layer has a total light transmittance of 40% or more and a diffuse transmittance of 70% or less;

(III) the hard coat layer has a tensile strength of 15 to 100 N/mm² in an atmosphere of 25° C. and 50% RH;

(IV) the acrylic copolymer (A) has a hydroxy value of 5 to 210 mgKOH/g, an acid value of 0 to 20 mgKOH/g, a glass transition temperature of 0 to 95° C., a weight-average molecular weight (Mw) of 100,000 to 1,000,000, and weight-average molecular weight/number-average molecular weight (hereinafter, also referred to as a polydispersity index) of 2.3 to 10;

(V) the acrylic copolymer (A) is a copolymer consisting of units derived from monomers having hydroxy group(s) and a unit derived from an additional monomer;

(VI) a content percentage of a unit derived from a monomer having one hydroxy group (monomer having one hydroxy group in the molecule) in 100% by mol of the units derived from monomers having hydroxy group(s) is 50% by mol or more; and

(VII) 56% or more of the hydroxy groups in the acrylic copolymer (A) is a primary hydroxy group.

As defined in the condition (I), the hard coat layer is obtained by curing a coating of the coating material comprising an acrylic copolymer (A) having hydroxy groups and an isocyanate curing agent (B). This can achieve both moldability and a surface hardness that cannot be obtained in acrylic resin films obtained by melt-extruding a thermoplastic acrylic resin. This can also secure light resistance that cannot be obtained in UV-cured acrylic resin films.

### <Acrylic Copolymer (A) Having Hydroxy Groups>

The acrylic copolymer (A) having hydroxy groups is obtained by copolymerizing monomers having hydroxy group(s) with an additional monomer having no hydroxy group. Specifically, the acrylic copolymer (A) is a copolymer consisting of units derived from monomers having hydroxy group(s) and a unit derived from an additional monomer.

The content percentage of a monomer having one hydroxy group in 100% by mol of the monomers having hydroxy group(s) which are subjected to the polymerization for the acrylic copolymer (A) having hydroxy groups to constitute the acrylic copolymer (A) is 50% by mol or more. A monomer feeding rate is almost equal to the compositional ratio of a polymer. Therefore, the content percentage of a unit derived from a monomer having one hydroxy group in 100% by mol of the units derived from monomers having hydroxy group(s), constituting the acrylic copolymer (A) is substantially 50% by mol or more.

In the case of curing the acrylic copolymer (A) having introduced hydroxy groups with the isocyanate curing agent (B), the intralayer cross-links of the hard coat layer are more homogeneous by use of the monomer having one hydroxy group. A copolymer having hydroxy groups introduced by use of a monomer having two or more hydroxy groups has a plurality of hydroxy groups at one side chain of the copolymer. Therefore, curing reaction with the isocyanate curing agent (B) might occur within the one side chain. The resulting cured coating is inferior in abrasion resistance or chemical resistance, as compared with the case of intermolecular cross-linking using a copolymer having one hydroxy group at one side chain.

Hydroxy groups in a copolymer having a plurality of hydroxy groups at one side chain are more localized in the backbone than hydroxy groups in a copolymer having one hydroxy group at one side chain, provided that the copolymers have equivalent hydroxy values. Thus, the intermolecular cross-linking of the copolymer having a plurality of hydroxy groups at one side chain tends to result in inhomogeneous cross-links. The resulting cured coating is inferior in abrasion resistance or chemical resistance.

On the other hand, a site with a large distance between cross-linking points appears by use of the copolymer having a plurality of hydroxy groups at one side chain. This tends to improve moldability, as compared with a copolymer having hydroxy groups introduced with the monomer having one hydroxy group.

Examples of the monomer having one hydroxy group include hydroxyalkyl (meth)acrylates and compounds containing ε-caprolactone added to the hydroxyalkyl (meth)acrylates. A hydroxyalkyl (meth)acrylate is preferred.

Specific examples of the hydroxyalkyl (meth)acrylates include hydroxyalkyl (meth)acrylates containing an alkyl group having 1 to 4 carbon atoms, such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate.

Specific examples of the compounds containing ε-caprolactone added to the hydroxyalkyl (meth)acrylates include ε-caprolactone adducts of the hydroxyalkyl (meth)acrylates having 1 to 4 carbon atoms, such as a 1-mol ε-caprolactone adduct of 2-hydroxyethyl (meth)acrylate, a 2-mol ε-caprolactone adduct of 2-hydroxyethyl (meth)acrylate, and a 3-mol ε-caprolactone adduct of 2-hydroxyethyl (meth)acrylate, though the present disclosure is not limited by these examples. These hydroxy group-containing monomers may each be used alone or may be used in combination.

Examples of the monomer having two or more hydroxy groups include 1,1-dihydroxymethyl (meth)acrylate, 1,2-dihydroxyethyl (meth)acrylate, 2,2-dihydroxyethyl (meth)acrylate, 2,3-dihydroxypropyl (meth)acrylate, and a monomer obtained by reacting a (meth)acryloyl monomer having an epoxy group in one molecule with a compound having one functional group reactable with the epoxy group in one molecule, and a hydroxy group, or water to ring-open the epoxy group, though the present disclosure is not limited by these examples. These hydroxy group-containing monomers may each be used alone or may be used in combination.

56% or more of the hydroxy groups in the acrylic copolymer (A) is a primary hydroxy group. Specifically, the types and amounts of the monomers having hydroxy group(s) are selected and used in polymerization such that the ratio of the primary hydroxy group to the hydroxy groups in the acrylic copolymer (A) falls within the range described above. The primary hydroxy group preferably occupies 80% or more, more preferably 90% or more. The primary hydroxy group is richer in reactivity with the isocyanate curing agent (B) than a secondary hydroxy group or a tertiary hydroxy group. Thus, with increase in the ratio of the primary hydroxy group, unreacted components are less likely to remain in a cured coating, and abrasion resistance and sunscreen cream resistance are improved.

The types and amounts of the hydroxy groups in the acrylic copolymer (A) can be determined from the respective amounts (mol) of the monomers having hydroxy group(s) subjected to the formation of the acrylic copolymer (A) and functional groups of primary and non-primary hydroxy groups in each monomer.

The hydroxy value of the acrylic copolymer (A) is preferably 5 to 210 mgKOH/g. When the hydroxy value of the acrylic copolymer (A) is 5 mgKOH/g or higher, the durability of a cured film can be secured. When the hydroxy value is 210 mgKOH/g or lower, the moldability of a cured film can be secured. In the case of, for example, laminating the coating material comprising the acrylic copolymer, on a polycarbonate base material by coating, the hydroxy value of the acrylic copolymer (A) is preferably 50 mgKOH/g or lower from the viewpoint of adhesion to the base material. When the hydroxy value is 50 mgKOH/g, the hard coat layer adheres favorably to the polycarbonate base material layer. For use of other base materials, 150 mgKOH/g or lower is more preferred. As mentioned later, when the hard coat layer is isolated (the isolated one is referred to as a cast film) and bonded to the base material layer using an adhesive, the hydroxy group is preferably 50 mgKOH/g or higher, more preferably 70 mgKOH/g or higher, from the viewpoint of film strength.

Examples of the additional acrylic monomer having no hydroxy group can include various monomers as described below. Examples of alkyl (meth)acrylates include alkyl (meth)acrylates such as methyl (meth)acrylate, ethyl (meth)acrylate, n-propyl (meth)acrylate, n-butyl (meth)acrylate, isobutyl (meth)acrylate, sec-butyl (meth)acrylate, tert-butyl (meth)acrylate, isoamyl (meth)acrylate, 2-ethylhexyl (meth)acrylate, isononyl (meth)acrylate, isodecyl (meth)acrylate, lauryl (meth)acrylate, stearyl (meth)acrylate, and tert-butylhexyl (meth)acrylate, 2-acetoacetoxyethyl (meth)acrylate, and phenoxyethyl (meth)acrylate.

Examples of monomers having an alicyclic hydrocarbon group include cyclopentyl (meth)acrylate, cyclohexyl (meth)acrylate, methylcyclohexyl (meth)acrylate, cyclododecyl (meth)acrylate, bornyl (meth)acrylate, isobornyl (meth)acrylate, dicyclopentenyl (meth)acrylate, and dicyclopentanyl (meth)acrylate.

Examples of monomers having an epoxy group include glycidyl (meth)acrylate, α-methylglycidyl acrylate, α-methylglycidyl methacrylate, 3,4-epoxycyclohexylmethyl acrylate, and 3,4-epoxycyclohexylmethyl methacrylate.

The acrylic copolymer (A) having hydroxy groups is preferably prepared by polymerizing methacrylate monomers among various monomers described above.

Examples of methods for polymerizing the monomers include solution polymerization, bulk polymerization, suspension polymerization, and emulsion polymerization methods, though the present disclosure is not limited by these polymerization methods. Among these polymerization methods, the solution polymerization method is preferred because the resulting reaction mixture can be used directly.

Hereinafter, one embodiment in which the acrylic copolymer (A) having hydroxy groups is prepared by the solution polymerization of the monomers will be described. However, the present disclosure is not limited by this embodiment.

Examples of a solvent for use in the solution polymerization of monomers include: aromatic solvents such as toluene and xylene; alcohol solvents such as n-butyl alcohol, propylene glycol monomethyl ether, diacetone alcohol, and ethyl cellosolve; ester solvents such as ethyl acetate, butyl acetate, and cellosolve acetate; ketone solvents such as methyl ethyl ketone, methyl isobutyl ketone, and cyclohexanone; and dimethylformamide, though the present disclosure is not limited by these examples. It is preferred that the amount of the solvent should be appropriately determined according to the concentration of a monomer mixture, the molecular weight of the acrylic copolymer of interest, etc.

Examples of a polymerization initiator include 2,2′-azobis-(2-methylbutyronitrile), tert-butylperoxy-2-ethyl hexanoate, 2,2′-azobisisobutyronitrile, benzoyl peroxide, and di-tert-butyl peroxide, though the present disclosure is not limited by these examples. The amount of the polymerization initiator is usually preferably 0.01 to 30 parts by mass, more preferably 0.05 to 10 parts by mass, per 100 parts by mass of a monomer mixture. When the weight-average molecular weight (Mw) is 100,000 or larger as in the present disclosure, the amount of the polymerization initiator is preferably 0.05 to 0.1 parts by mass.

The polymerization temperature for polymerizing the monomers is usually preferably 40 to 200° C., more preferably 40 to 160° C. When the weight-average molecular weight (Mw) is 100,000 or larger as in the present disclosure, the polymerization temperature is preferably 90° C. or lower.

The monomer polymerization time differs depending on the polymerization temperature, the composition of a monomer mixture, the type and amount of the polymerization initiator, etc. and therefore cannot be generalized. Therefore, it is preferred that the polymerization time should be appropriately determined according thereto.

The acrylic copolymer (A) may have an acid value. Owing to the acid value, the reaction of the hydroxy groups with isocyanate is accelerated. Therefore, a highly durable cured film can be obtained. In the case of conferring the acid value, the acid value of the acrylic copolymer (A) is preferably 20 mgKOH/g or lower. When the acid value is 20 mgKOH/g or lower, durability can be conferred without impairing moldability. The acid value is more preferably 15 mgKOH/g or lower.

A method for imparting the acid value to the acrylic copolymer (A) is to copolymerize a monomer having the acid value with an additional monomer. Examples of the monomer having the acid value include (meth)acrylic acid, maleic anhydride, 2-(meth)acryloyloxyethyl-succinic acid, 2-(meth)acryloyloxyethyl-hexahydrophthalic acid, 2-(meth)acryloyloxyethyl-phthalic acid, and 2-(meth)acryloyloxyethyl acid phosphate. Among them, (meth)acrylic acid is preferably used.

The acrylic copolymer (A) has a glass transition temperature of 0 to 95° C., preferably 80° C. or lower. When the glass transition temperature is 0° C. or higher, favorable scratch resistance and abrasion resistance are obtained. When the glass transition temperature is 95° C. or lower, favorable moldability is obtained. The glass transition temperature of the acrylic copolymer (A) is determined depending on the compositional ratio of the additional monomer to be copolymerized with the hydroxy group-containing monomers and the acidic functional group-containing monomer.

In this context, the glass transition temperature refers to a glass transition temperature measured by differential scanning calorimetry (DSC) as to a resin having 100% solids by drying a solution of the acrylic copolymer (A). The glass transition temperature of the present disclosure refers to a value determined according to Examples mentioned later.

The weight-average molecular weight (Mw) of the acrylic copolymer (A) is 100,000 to 1,000,000, preferably 200,000 to 800,000. In general, hard acrylic copolymers may be fragile and, and highly extensible acrylic copolymers may have a low strength. Therefore, as mentioned above, conventional decorative films containing such an acrylic copolymer fail to achieve both moldability and a surface hardness, etc. The acrylic copolymer (A) of the present disclosure having a weight-average molecular weight of 100,000 or larger can offer both moldability and a surface hardness. When the weight-average molecular weight is 1,000,000 or smaller, a hard coat layer having favorable surface smoothness can be obtained by preventing gel formation.

The polydispersity index (Mw/Mn) of the acrylic copolymer (A) is preferably 2.3 to 10. When polymers having equivalent weight-average molecular weights are compared, the amount of low-molecular-weight components contained in a polymer having a small polydispersity index is relatively small whereas a polymer having a large polydispersity index is relatively rich in low-molecular-weight components. The polymers may also contain molecules that are not directly involved in curing reaction. Among the molecules that are not directly involved in curing reaction, low-molecular-weight components work as plasticizers. Therefore, the physical properties of a film after curing vary largely depending on the polydispersity index.

Specifically, when the polydispersity index is 2.3 or more, the cross-link density of a cured coating is moderately decreased to improve moldability. On the other hand, when the polydispersity index is 10 or less, the plasticity of a cured coating can be moderately suppressed to maintain abrasion resistance. The polydispersity index is more preferably 3 to 9, further preferably 4 to 8.

The weight-average molecular weight/number-average molecular weight described above refers to a value determined by a method described in Examples mentioned later.

In order to set the weight-average molecular weight (Mw) of the acrylic copolymer (A) to 100,000 or higher, a method is adopted, such as (1) to decrease the amount of the initiator, (2) to lower the reaction temperature, (3) to elevate the monomer concentration, or (4) to use a solvent having low chain transferability. One of or a combination of two or more of these methods may be used.

<Isocyanate Curing Agent (B)>

The isocyanate curing agent (B) reacts with the hydroxy groups serving as cross-linkable functional groups in the acrylic copolymer (A) having hydroxy groups mentioned above to form a cross-linked cured resin layer. The blending ratio between the acrylic copolymer (A) and the isocyanate curing agent (B) in the coating material for forming the hard coat layer is preferably NCO/OH=1/1 to 3/1 in terms of the ratio of the isocyanate groups in the isocyanate curing agent (B) to the hydroxy groups in the acrylic copolymer (A) with respect to 100 parts by mass (solids) of the acrylic copolymer (A) having hydroxy groups of the present disclosure. When 1 mol or more of the isocyanate groups is used with respect to 1 mol of the hydroxy groups, the cross-linking reaction of the acrylic copolymer (A) with the isocyanate curing agent (B) proceeds to obtain an acrylic resin layer having favorable scratch resistance and abrasion resistance that cannot be obtained in mere extruded thermoplastic acrylic films. When 3 mol or less of the isocyanate groups is used with respect to 1 mol of the hydroxy groups, deep draw molding is possible by suppressing excessive cross-linking reaction.

For the isocyanate curing agent (B), it is important to have two or more isocyanate groups in one molecule. Examples thereof include aromatic isocyanates, aliphatic isocyanates, and alicyclic isocyanates. Among them, an aliphatic isocyanate curing agent is preferably used from the viewpoint of preventing the yellowing of a molded decorative film. The isocyanate curing agent (B) may be of one type, or two or more types of curing agents may be used in combination. An additional curing agent reactive with hydroxy groups may be used without influencing the physical properties of the decorative film of the present disclosure.

Examples of the aromatic isocyanates include 1,3-phenylene diisocyanate, 4,4′-diphenyl diisocyanate, 1,4-phenylene diisocyanate, 4,4′-diphenylmethane diisocyanate, 2,4-tolylene diisocyanate, 2,6-tolylene diisocyanate, 4,4′-toluidine diisocyanate, 2,4,6-triisocyanatotoluene, 1,3,5-triisocyanatobenzene, dianisidine diisocyanate, 4,4′-diphenyl ether diisocyanate, and 4,4′,4″-triphenylmethane triisocyanate.

Examples of the aliphatic isocyanates include trimethylene diisocyanate, tetramethylene diisocyanate, hexamethylene diisocyanate (HDI), pentamethylene diisocyanate, 1,2-propylene diisocyanate, 2,3-butylene diisocyanate, 1,3-butylene diisocyanate, dodecamethylene diisocyanate, and 2,4,4-trimethylhexamethylene diisocyanate.

Examples of the alicyclic isocyanates include 3-isocyanatomethyl-3,5,5-trimethylcyclohexyl isocyanate (IPDI), 1,3-cyclopentane diisocyanate, 1,3-cyclohexane diisocyanate, 1,4-cyclohexane diisocyanate, methyl-2,4-cyclohexane diisocyanate, methyl-2,6-cyclohexane diisocyanate, 4,4′-methylenebis(cyclohexyl isocyanate), and 1,4-bis(isocyanatomethyl)cyclohexane.

These isocyanate curing agents are more preferably used as adducts of the isocyanates with a polyol compound such as trimethylolpropane, burette or isocyanurate forms of the isocyanates, or adducts of the isocyanates with a polyether polyol, a polyester polyol, an acrylic polyol, a polybutadiene polyol, a polyisoprene polyol, or the like known in the art.

Among these isocyanate curing agents (B), an aliphatic or alicyclic isocyanate of low yellowing type is preferred from the viewpoint of design, and an adduct is preferred from the viewpoint of the coating strength of a cured coating. More specifically, an adduct of hexamethylene diisocyanate (HDI) or an adduct of 3-isocyanatomethyl-3,5,5-trimethylcyclohexyl isocyanate (IPDI) is preferred. Also, a mixture thereof is suitably used.

In the present disclosure, a blocked isocyanate curing agent may be used from the viewpoint of the preservation stability of the coating material for hard coat layer formation. A blocked form of the non-blocked isocyanate curing agent described above using any of various blocking agents is used as the blocked isocyanate curing agent. It is preferred that the blocking agent should be dissociated at a relatively low temperature on the order of 80° C. to 120° C. In the case of using the non-blocked isocyanate curing agent, a method is suitably used which involves separately packaging the acrylic copolymer (A) having hydroxy groups and the isocyanate curing agent (B) and mixing them immediately before use.

### <Coating Material for Forming Hard Coat Layer>

The coating material contains a solvent in addition to the acrylic copolymer (A) and the isocyanate curing agent (B). The type of the solvent is not particularly limited, and any of those known in the art can be used. An organic solvent is preferred from the viewpoint of the solubility of the acrylic copolymer (A) or the isocyanate curing agent (B).

Examples of the organic solvent include: aromatic solvents such as toluene and xylene; ester solvents such as ethyl acetate, butyl acetate, and cellosolve acetate; and ketone solvents such as methyl ethyl ketone and methyl isobutyl ketone.

In the case of using a plastic having poor solvent resistance (e.g., polycarbonate) as the base material layer, the solvent preferably contains at least one type of alcohol, methyl isobutyl ketone (hereinafter, also referred to as MIBK) or propylene glycol monomethyl ether acetate (hereinafter, also referred to as PGMAC). The alcohol can be used provided that the isocyanate curing agent (B) is a blocked isocyanate. A higher alcohol having poor reactivity with isocyanate groups can be used even for a non-blocked isocyanate.

Use of these solvents in coating a polycarbonate base material with the coating material of the present disclosure neither whitens the surface of the base material layer nor warp the polycarbonate base material during drying or curing after the coating.

In the case of using MIBK or/and PGMAC, the ratio between MIBK and PGMAC in 100% by mass in total of MIBK and PGMAC is preferably MIBK/PGMAC=100/0 to 0/100. MIBK and PGMAC preferably occupy 70% by mass or more in total in 100% by mass of the organic solvents used.

Even in the case of using polycarbonate or the like as the base material layer, a solvent other than MIBK and PGMAC can also be used unless the base material layer is directly coated with the coating material. Specifically, the freedom of choice of the solvent to be contained in the coating material is increased in the case of separately coating a strippable film with the coating material, volatilizing the solvent, curing the acrylic copolymer (A) having hydroxy groups with the isocyanate curing agent (B) to form a hard coat layer, and then laminating the hard coat layer on the base material layer using an adhesive layer.

The solvent used preferably has a boiling point of 50° C. to 200° C. If the boiling point is lower than 50° C., the solvent is easily volatilized during application of the coating material serving as a curable composition onto the base material film. Due to percent solids thus increased, it is difficult to apply the coating material with a uniform film thickness. If the boiling point is higher than 200° C., the solvent is difficult to dry. Two or more solvents may be used.

In the present disclosure, the coating material can further contain an ultraviolet absorber, an ultraviolet stabilizer, or the like for the purpose of imparting weather resistance to the hard coat layer to be formed. Examples of the ultraviolet absorber include ultraviolet absorbers including: organic ultraviolet absorbers such as benzotriazole ultraviolet absorbers, benzophenone ultraviolet absorbers, triazine ultraviolet absorbers, and indole ultraviolet absorbers; and inorganic ultraviolet absorbers such as zinc oxide. An ultraviolet stabilizer such as a hindered amine compound is suitably used as the ultraviolet stabilizer. The ultraviolet absorber or the ultraviolet stabilizer may be added as an additive to the coating material, or the ultraviolet absorber or the ultraviolet stabilizer having a functional group may be used through reaction with the acrylic copolymer or may be used through reaction with other resins. The ultraviolet absorber or the ultraviolet stabilizer is preferably used at 0.1 to 20 parts by mass, more preferably 0.5 to 10 parts by mass, with respect to 100 parts by mass (solids) of the coating material excluding the ultraviolet absorber or the ultraviolet stabilizer.

In the present disclosure, a slip agent can be added to the coating material for the purpose of imparting slidability to the hard coat layer. Examples of the slip agent include fluorine slip agents, silicone slip agents, and wax slip agents. The slip agent is preferably used at 0.01 to 20 parts by mass, more preferably 0.1 to 10 parts by mass, with respect to 100 parts by mass (solids) of the coating material.

The coating material for hard coat layer formation is applied so as to form a relatively thick film and therefore, in general, tends to cause surface defects due to the increased film thickness. In the present disclosure, a surface conditioner or the like may be added to the coating material for the purpose of more effectively preventing surface defects. Examples of the surface conditioner include BYK-300, BYK-315, and BYK-320 manufactured by BYK Additives & Instruments. The surface conditioner is preferably used at 0.01 to 20 parts by mass, more preferably 0.1 to 10 parts by mass, with respect to 100 parts by mass (solids) of the coating material.

In the present disclosure, a polyol can be added thereto in order to improve moldability. In this context, the polyol is a compound, other than the acrylic copolymer (A), containing two or more hydroxy groups reactable with isocyanate groups. Examples thereof include polyether polyols, polyester polyols, and polycarbonate polyols. One type or two or more types in combination can be used. Particularly, a polyester polyol is preferred from the viewpoint of the durability and moldability of a cured film.

Examples of the polyester polyols specifically include terminal hydroxy group-containing ester compounds obtained by esterifying at least one dicarboxylic acid with at least one polyol such as a polyhydric alcohol, a polyhydric phenol, or an alkoxy-modified form thereof. Examples of the dicarboxylic acid include dicarboxylic acids such as terephthalic acid, isophthalic acid, orthophthalic acid, 1,5-naphthalic acid, p-oxybenzoic acid, p-(hydroxy)benzoic acid, 1,4-cyclohexanedicarboxylic acid, succinic acid, adipic acid, azelaic acid, sebacic acid, and dodecanedicarboxylic acid.

Examples of the polyhydric alcohol include 1,3-propanediol, 2-methyl-1,3-propanediol, 1,4-butanediol, 2-methyl-1,4-butanediol, 1,2-dimethyl-1,4-butanediol, 2-ethyl-1,4-butanediol, 1,5-pentanediol, 2-methyl-1,5-pentanediol, 3-methyl-1,5-pentanediol, 2,2,4-trimethyl-1,3-pentanediol, 3-ethyl-1,5-pentanediol, 1,6-hexanediol, 2-methyl-1,6-hexanediol, 3-methyl-1,6-hexanediol, 1,7-heptan, 1,7-heptanediol, 3-methyl-1,7-heptanediol, 4-methyl-1,7-hexanediol, 1,7-heptanediol, 2-methyl-1,7-heptanediol, 3-methyl-1,7-heptanediol, 4-methyl-1,7-heptanediol, 1,8-octanediol, 2-methyl-1,8-octanediol, 2-ethyl-1,8-octanediol, 3-methyl-1,8-octanediol, 4-methyl-1,8-octanediol, 1,9-nonanediol, ethylene glycol, propylene glycol, neopentyl glycol, diethylene glycol, dipropylene glycol, cyclohexanedimethanol, polyethylene glycol, polypropylene glycol, polytetramethylene glycol, trimethylolpropane, 1,1,1-trimethylolpropane ethylene glycol, glycerin, erythritol, xylitol, sorbitol, and mannitol.

Examples of the polyhydric phenol include catechol, resorcin, hydroquinone, hexylresorcin, trihydroxybenzene, and dimethylol phenol.

Examples of commercially available products of the polyester polyols having two or more hydroxy groups include Kuraray Polyols P-510, P-1010, P-2010, P-3010, P-4010, P-5010, P-6010, P-2011, P-2012, P-520, P-1020, P-2020, P-1012, P-530, P-2030, F-510, F-1010, F-2010, F-3010, and N-2010 manufactured by Kuraray Co., Ltd.

Examples of the polyether polyols include polyalkylene glycols such as polyethylene glycol, polypropylene glycol, and polytetramethylene glycol. Examples of commercially available polyether polyols having two or more hydroxy groups include PTG1000, PTG2000, and PTG3000 manufactured by Hodogaya Chemical CO., Ltd., PTMG650, PTMG850, PTMG1000, PTMG1300, PTMG1500, PTMG1800, PTMG2000, and PTMG3000 manufactured by Mitsubishi Chemical Corp., and SANNIX PP1000, SANNIX PP2000, and SANNIX PP3000 manufactured by Sanyo Chemical Industries, Ltd.

Examples of the polycarbonate polyols include a polycarbonate diol represented by the following general formula:

H—(O—R—OCO—)ₙ—ROH

wherein R represents an alkyl chain, diethylene glycol, or the like.

Examples of commercially available polycarbonate polyols having two or more hydroxy groups include Kuraray Polyols C-590, C-1090, C-2090, and C-3090 manufactured by Kuraray Co., Ltd. These polyol compounds can be used alone or in combination of two or more.

The polyol has a number-average molecular weight of preferably 500 to 7000, more preferably 800 to 6000. When the number-average molecular weight is 500 or larger, sufficient flexibility can be conferred. The polyol having a number-average molecular weight of 7000 or smaller is preferred because of having a proper degree of cross-linking. Its hydroxy value is preferably 10 mgKOH/g or higher, more preferably 15 mgKOH/g or higher. When the hydroxy value is 10 mgKOH/g or higher, abrasion properties are improved owing to a high degree of cross-linking. When the hydroxy value is 15 mgKOH/g, abrasion properties are further improved because the degree of cross-linking can be further enhanced. Thus, more preferably, the number-average molecular weight is 800 to 6000, and the hydroxy value is 15 mgKOH/g or higher.

The content of the polyol compound other than the acrylic copolymer (A) is not particularly limited as long as the content does not impair the effect of the present disclosure. The content of the polyol is preferably 200 parts by mass or less, more preferably 100 parts by mass or less, further preferably 50 parts by mass or less, with respect to 100 parts by mass of the acrylic copolymer (A) contained in the coating material for hard coat layer formation. When the polyol content is 200 parts by mass or less with respect to 100 parts by mass of the acrylic copolymer (A), moldability can be drastically improved without markedly impairing durability.

In the present disclosure, the coating material for hard coat layer formation may contain an additional resin other than the acrylic copolymer (A) having hydroxy groups, organic or inorganic fine particles, an organic solvent, etc., without inhibiting the object of the present disclosure. Examples of the additional resin other than the acrylic copolymer (A) having hydroxy groups can include polyester resins, urethane resins, epoxy resins, thermoplastic acrylic resins, phenol resins, and cellulose ester resins. These resins may or may not have a cross-linkable functional group. Preferably, the resins have a cross-linkable functional group.

In the present disclosure, the coating material for hard coat layer formation contain organic or inorganic fine particles and can thereby confer a blocking preventive effect by rendering the surface of the hard coat layer irregular, offer matte appearance ascribable to the irregular surface, and render a coating scratch-proof by strengthening the coating. These fine particles are preferably contained at 0.01 to 20 parts by mass, more preferably 0.1 to 10 parts by mass, with respect to 100 parts by mass of the acrylic copolymer (A). When the content is 0.01 parts by mass or more, the effects described above can be expected. When the content is 20 parts by mass or less, a robust hard coat layer excellent in moldability without inhibiting transparency can be formed.

Specific examples of the organic fine particles include fine particles of polymers such as polytetrafluoroethylene resins, polyethylene resins, polypropylene resins, polymethyl methacrylate resins, polystyrene resins, polyamide resins, melamine resins, guanamine resins, phenol resins, urea resins, silicone resins, methacrylate resins, and acrylate resins, cellulose powders, nitrocellulose powders, wood powders, waste paper powders, shell flour, and starch. One type of organic particles may be used, or two or more types may be used in combination.

Specific examples of the inorganic fine particles include inorganic fine particles containing oxide, hydroxide, sulfate, carbonate, silicate, or the like of a metal such as magnesium, calcium, barium, zinc, zirconium, molybdenum, silicon, or antimony. More detailed specific examples thereof include inorganic fine particles containing silica, silica gel, aluminum oxide, aluminum hydroxide, calcium hydroxide, calcium carbonate, magnesium oxide, magnesium hydroxide, aluminosilicate, talc, mice, glass fiber, a glass powder, or the like. One type of inorganic particles may be used, or two or more types may be used in combination.

A curing accelerator may also be added, if necessary, to the coating material for hard coat layer formation, without impairing the effect of the present disclosure. The curing accelerator plays a role as a catalyst that accelerates the urethane bonding reaction of the hydroxy groups in the acrylic copolymer (A) having hydroxy groups with the isocyanate curing agent (B). Examples of the curing accelerator include tin compounds, metal salts, and bases. Specific examples thereof include tin octylate, dibutyltin diacetate, dibutyltin dilaurate, dioctyltin dilaurate, tin chloride, iron octylate, cobalt octylate, zinc naphthenate, triethylamine, and triethylenediamine. These curing accelerators can be used alone or in combination.

Various additives such as a filler, a thixotropy-imparting agent, an antiaging agent, an antioxidant, an antistatic agent, a flame retardant, a thermal conductivity-improving agent, a plasticizer, an anti-sagging agent, an antifoulant, an antiseptic, a bactericide, an antifoaming agent, a leveling agent, a curing agent, a thickener, a pigment dispersant, and a silane coupling agent may be further added, if necessary, to the coating material for hard coat layer formation without impairing the effect of the present disclosure.

The coating material for hard coat layer formation can be obtained as follows: for example, predetermined amounts of the acrylic copolymer (A) having hydroxy groups, the isocyanate curing agent (B), and a solvent (preferably an organic solvent) can be weighed and blended into a container, and thoroughly stirred in a stirrer to obtain the coating material for hard coat layer formation. The weight-average molecular weight (Mw) of the acrylic copolymer (A) is preferably 1,000,000 or smaller. If Mw exceeds 1,000,000, the resulting coating material has a high viscosity and tends to cause fish eyes, etc. derived from a gel during coating. The solvent plays a role in adjusting the viscosity and flowability of the coating material. The solvent used in the polymerization for the acrylic copolymer (A) may be used directly, or the solvent can also be further added during coating material preparation.

The coating material for hard coat layer formation is preferably degassed before coating of the base material layer or a strippable film. If the coating material contains bubbles, a coating in the course of formation may be contaminated with the bubbles during the coating of the base material layer or a strippable film so that residues of broken bubbles may remain on the surface of the coating after drying or curing. As for a method for the degassing, the stirred mixture may be left until the bubbles disappear or may be forcedly degassed in a vacuum degassing machine or the like.

### <Hard Coat Layer>

As mentioned above, the hard coat layer consists of a cured product of the coating material comprising the acrylic copolymer (A) and the isocyanate curing agent (B). The hard coat layer has a total light transmittance of 40% or more and a diffuse transmittance of 70% or less. The large total light transmittance and diffuse transmittance can render a colored layer or a printing layer more clearly visible through the hard coat layer when the colored layer or the printing layer is disposed between the base material layer and the main body of a decoratable object such as a molded article or between the hard coat layer and the base material layer. More preferably, the total light transmittance is 60% or more, and the diffuse transmittance is 50% or less, from the viewpoint of such improvement in visibility.

The tensile strength of the hard coat layer according to the present disclosure in an atmosphere of 25° C. and 50% RH is 15 to 100 N/mm². When the tensile strength is 15 N/mm² or larger, the cracking or whitening of the hard coat layer during molding can be suppressed. When the tensile strength is 100 N/mm² or smaller, the property of following the shape of a decoratable object during molding is excellent, and poor molding such as the uplift of the decorative film from the decoratable object can be suppressed. The tensile strength is more preferably 20 to 100 N/mm².

Alternatively, the hard coat layer is formed on a strippable film, isolated by peeling off the hard coat layer from the strippable film, and then bonded to the base material layer via a laminate adhesive. The tensile strength in this operation is preferably 30 N/mm² or larger. When the hard coat layer having a tensile strength of 30 N/mm² or larger is handled as an acrylic cast film, the cured acrylic cast film can be rapidly stripped without delay from the base material film subjected to stripping treatment mentioned later. On the other hand, this does not necessarily true when the hard coat layer is disposed on the base material layer by direct coating with a coating liquid.

The tensile strength of the present disclosure in an atmosphere of 25° C. and 50% RH is a value measured by a method described in Examples mentioned later.

The isolated hard coat layer (also referred to as a cast film) is pulled by the application of force, and a stress-strain curve is drawn. In this case, the strain first exhibits a constant slope against the stress. Once the stress reaches a certain point, the strain exhibits increase whereas the stress is decreased. In this respect, the film is regarded as yielding. The stress at this point is called “yield value” and was used as the tensile strength according to the present disclosure. Deformation up to the yield point is elastic deformation, and the film returns to its original shape as long as the load is removed. Plastic deformation begins at the yield point, and the film cannot return its original shape and has residual deformation corresponding to at least the elastic deformation even if the load is removed.

The rate of elongation at break of the hard coat layer of the present disclosure in an atmosphere of 25° C. and 50% RH is preferably 10% or more. When the rate of elongation is 10% or more, the hard coat layer can follow a molding die and can be easily molded. Although there is no upper limit on the rate of elongation, the rate of elongation is preferably 10 to 200% from the viewpoint of achieving both moldability and durability. The rate of elongation according to the present disclosure indicates the extent to which a sample is extended with respect to the original length. For example, a rate of elongation of 0% means that the sample is not elongated. A rate of elongation of 100% means that the sample is elongated twice the original length (when the original length is 10 mm, the sample is elongated by 10 mm so that the total length is 20 mm).

The thickness of the hard coat layer is not particularly limited and is preferably 5 to 200 μm, more preferably 10 to 100 μm, from the viewpoint of moldability and durability.

### <Base Material Layer>

The base material layer of the present disclosure plays a role in supporting the hard coat layer and an additional layer such as a colored layer or an adhesive layer mentioned later.

The base material layer is not particularly limited as long as the base material layer is a film that plays a role as a support. Any of those known in the art can be used. Examples thereof include polyethylene films, polypropylene films, polyester films, polycarbonate films, polymethyl methacrylate films, polyamide films, polyimide films, polyvinyl chloride films, polyvinylidene chloride films, polyvinyl alcohol films, polystyrene films, polyacrylonitrile films, aluminum foil, and paper. One type of film or a laminate of plural types can be used. Particularly, a polyester film, a polycarbonate film, or a polymethyl methacrylate film is preferred from the viewpoint of transparency and moldability. These films can also be used alone, or a laminate of plural types can be used. For example, a PMMA/PC film prepared by coextruding polymethyl methacrylate (PMMA) onto polycarbonate (PC), or a film prepared by laminating a polycarbonate film and a polyester film via an adhesive can also be used. The polycarbonate film is characterized by having good moldability. The polyester film is characterized by having good solvent resistance (against organic solvents, sunscreen creams, etc.). The polymethyl methacrylate film is characterized by having a good hardness. Therefore, one or a combination of these films can be appropriately selected and used according to an intended purpose.

As for the total light transmittance and the diffuse transmittance, the base material layer also preferably has a total light transmittance of 40% or more and a diffuse transmittance of 70% or less, as in the hard coat layer. This does not necessarily hold true for, for example, a configuration in which a colored layer is disposed between the hard coat layer and the base material layer.

A strippable film may be laminated as a protective film on a non-facing side (that does not face the hard coat layer) of the base material layer. Particularly, a polycarbonate base material is vulnerable and is therefore preferably protected at its back side with a protective film until just before use.

The thickness of the base material layer is not particularly limited and is preferably 5 to 1000 μm, more preferably 10 to 500 μm, further preferably 10 to 400 μm, from the viewpoint of moldability and durability. Plural types of base materials differing in thickness may be combined for the base material layer. In this case, the total thickness of these base material layers combined is preferably 5 to 1000 μm.

### <Method for Producing Decorative Film>

One example of a method for producing the decorative film of the present disclosure will be described. However, the method for producing the decorative film of the present disclosure is not limited by the method described below, as a matter of course.

First, a thermosetting coating material for forming the hard coat layer mentioned above is provided, the thermosetting coating material comprising an acrylic copolymer (A) having hydroxy groups and an isocyanate curing agent (B), wherein the hard coat layer which is a cured product of the coating material has a tensile strength of 15 to 100 N/mm² in an atmosphere of 25° C. and 50% RH. Furthermore, the method comprises the step of obtaining a coating layer by coating with the coating material and forming a laminate having a cured coating of the coating layer.

Examples of the coating with the coating material can include (α) a method of coating any layer constituting the decorative film comprising the laminate with the coating material, and (β) a method of coating a strippable film with the coating material.

An example of coating the base material layer will be described as one example of the method (α). First, one side of the base material layer is coated with the coating material for heart coat layer formation, followed by curing. Specifically, the base material layer is coated with the coating material of the present disclosure and immediately placed in a drying oven to volatilize the solvent. After the solvent volatilization, the resultant can be aged so that the hydroxy groups in the acrylic copolymer (A) are reacted with the isocyanate groups in the isocyanate curing agent (B) for curing to obtain a hard coat layer.

An example of using an adhesive will be described as one example of the method (β). First, a strippable film is coated with the coating material for hard coat layer formation and placed in a drying oven to volatilize the solvent. After the solvent volatilization, the resultant is aged so that the hydroxy groups in the acrylic copolymer (A) are reacted with the isocyanate groups in the isocyanate curing agent (B) to obtain a cured coating (cast film). Subsequently, the cast film or/and the base material layer is coated with an adhesive for laminates. When the adhesive for laminates contains a solvent, the solvent is volatilized, and then, the cast film and the base material layer can be laminated to obtain a decorative film having the heart coat layer and the base material layer. The strippable film is appropriately stripped before or after the lamination. In the case of laminating the hard coat layer after its formation with an additional constitutive layer such as the base material layer as mentioned above, the hydroxy value of the acrylic copolymer (A) is more preferably 50 to 210 mgKOH/g. Also, the tensile strength is more preferably 30 to 100 N/mm².

For any of the methods described above, a method known in the art can be used as a method for applying the coating material. Specific examples thereof can include comma coating, gravure coating, reverse coating, roll coating, lip coating, and spray coating.

The coating material is preferably dried at 50 to 200° C., more preferably 70 to 120° C. The oven is divided into zones of several stages, and the oven temperature is preferably set so as to have a gradient from a low temperature to a high temperature in such a way that, for example, the first zone is of 50° C., the second zone is of 70° C., and the third zone is of 100° C. The residence time in the oven is usually on the order of 1 minute to 10 minutes. A method may be adopted which involves providing several ovens set to fixed temperatures and performing drying for several minutes each in the ovens having the respective temperatures.

After the drying, the reaction of the hydroxy groups with the isocyanate groups is usually allowed to proceed (aging) for 1 day to 10 days in an environment of room temperature to approximately 100° C. Although a method may be selected which involves elevating the temperature of the oven to approximately 150 to 200° C. and completing the reaction of the hydroxy groups with the isocyanate groups while passing through the oven, the aging is preferably performed at a low temperature from the viewpoint of thermal damage on the base material layer.

The laminate retrieved after the drying of the solvent in the oven may be aged in a sheet form or may be wound up into a roll and then aged. In both cases, tack may remain in the coating before the aging and overlap with the opposite side of the base material layer to cause a blocking phenomenon. In order to prevent such a blocking phenomenon, a separator for blocking prevention can be laminated on the coating before lamination in a sheet form or winding up into a roll. A PET film subjected to mold release treatment, an unstretched propylene film, a polyethylene film, or the like is suitably used as the separator.

The decorative film of the present disclosure can be further provided with an adhesive layer and/or a colored layer as mentioned later. The adhesive layer is disposed between the hard coat layer and the base material layer and used to bond the hard coat layer to the base material layer, as mentioned above, and is also used to bond together various layers in the case of using a plurality of base material layers or in the case of using a colored layer.

For example, a first base material layer and a second base material layer can be bonded together using the adhesive layer. Alternatively, the adhesive layer may be disposed on the side, opposite to the hard coat layer, of the base material layer to bond the decorative film to a decoratable object such as a resin molded article.

The adhesive constituting the adhesive layer is not particularly limited, and any of those known in the art can be used. Examples thereof include thermosetting adhesives, pressure-sensitive adhesives, and hot-melt adhesives. One type or two or more types in combination can be used.

Examples of components constituting these adhesives include, but are not particularly limited to, polyester resins, poly(meth)acrylate resins, polyurethane resins, polyether resins, polyamide resins, polyimide resins, polyethylene resins, polystyrene resins, polypropylene resins, ethylene-vinyl acetate resins, polyvinyl alcohol resins, epoxy resins, silicone resins, phenol resins, styrene-butadiene rubbers, nitrile rubbers, and natural rubbers. One type or two or more types in combination can be used.

A method for establishing the adhesive layer will be described. The adhesive layer can be established by, for example, a method which involves directly coating the base material layer or the hard coat layer with a solvent-containing adhesive, followed by drying, a method which involves softening a solvent-free adhesive by heat and coating the base material layer or a hard coat (HC) with the resulting adhesive, followed by cooling, or a method which involves coating a strippable film with a solvent-containing or -free adhesive in the same way as above to obtain an adhesive sheet, and then allowing the adhesive sheet to be sandwiched between the layers to be bonded together. After the establishment of the adhesive layer, aging treatment may be further performed. The thickness of the adhesive layer is not particularly limited and can be arbitrarily set to a thickness that can secure adhesive force. The thickness is preferably in the range of 1 to 200 μm from the viewpoint of the balance between adhesive force and durability.

A method known in the art can be used as a method for applying the adhesive. Specific examples thereof can include comma coating, gravure coating, reverse coating, roll coating, lip coating, and spray coating.

The decorative film of the present disclosure may be further provided with a colored layer. The colored layer is laminated in order to impart design to the decorative film and can be disposed at any position that does not correspond to the outermost layer of a decorated molded article, such as the position between the hard coat layer and the base material layer or the side, opposite to the hard coat layer, of the base material layer. The term “colored” in the present disclosure is meant to include a single color as well as various ornaments such as pictures, patterns, metal tints, letters, and designs. Two or more different colored layers may be laminated thereon.

A method for obtaining the colored layer will be described. Examples of the colored layer include a method which involves coating the base material layer with a coloring coating material, followed by drying to obtain the colored layer, a method which involves coating the base material layer, followed by drying and aging to obtain the colored layer, a method which involves coating the base material layer, followed by light irradiation to obtain the colored layer, a method which involves printing the base material layer, followed by drying to obtain the colored layer, a method which involves printing the base material layer, followed by light irradiation to obtain the colored layer, and a method which involves depositing a metal on the base material layer to obtain the colored layer. The thickness of the colored layer is not particularly limited as long as the thickness allows intended color, pattern, or the like to be recognized. The thickness is preferably 500 μm or smaller from the viewpoint of moldability.

A method known in the art can be used as a method for disposing the colored layer on a base material. Specific examples thereof can include comma coating, gravure coating, reverse coating, roll coating, lip coating, spray coating, silk screen printing, offset printing, gravure printing, inkjet printing, and vapor deposition.

The decorative film of the present disclosure can be prepared into a decorated molded article by various molding methods such as vacuum molding, pressure molding, TOM molding, injection molding, in-mold molding, press molding, and stamping molding.

A strippable protective film can be further disposed on the hard coat layer from the viewpoint of blocking and scratch prevention during decorative film production, scratch and die mark prevention during molding, and prevention of contamination from after molding to use of the decorated molded article.

In the case of bonding the decorative film to a decoratable object to be decorated using the adhesive layer, a strippable protective film may be further disposed on the adhesive layer positioned inward of the decorative film from the viewpoint of blocking prevention.

The protective film that can be used in the present disclosure is not particularly limited and can be appropriately selected, for use, from plastic films and paper films known in the art. Examples of the film that can be used as the protective film include, but are not limited to, polyethylene films, polypropylene films, polyester films, polycarbonate films, polymethyl methacrylate films, polyamide films, polyimide films, polyvinyl chloride films, polyvinylidene chloride films, polyvinyl alcohol films, polystyrene films, polyacrylonitrile films, aluminum foil, and paper. One type of film or a laminate of plural types can be used. The plastic film serving as the protective film may be subjected to stripping treatment or pressure-sensitive adhesion treatment.

Examples of methods for disposing the protective film in the decorative film of the present disclosure include a method which involves applying a coating liquid onto the base material layer, followed by drying to establish the hard coat layer or the adhesive layer, which is then bonded to the protective film, and a method which involves applying a coating liquid onto the protective film, followed by drying and, if necessary, aging to establish the hard coat layer or the adhesive layer, which is then bonded to the base material layer or the decorative film. In the case of disposing the hard coat layer on the protective film in advance, they may be bonded together, if necessary, using an adhesive.

The decorative film of the present disclosure includes various forms. Specific examples of the forms will be described with reference to the drawings.

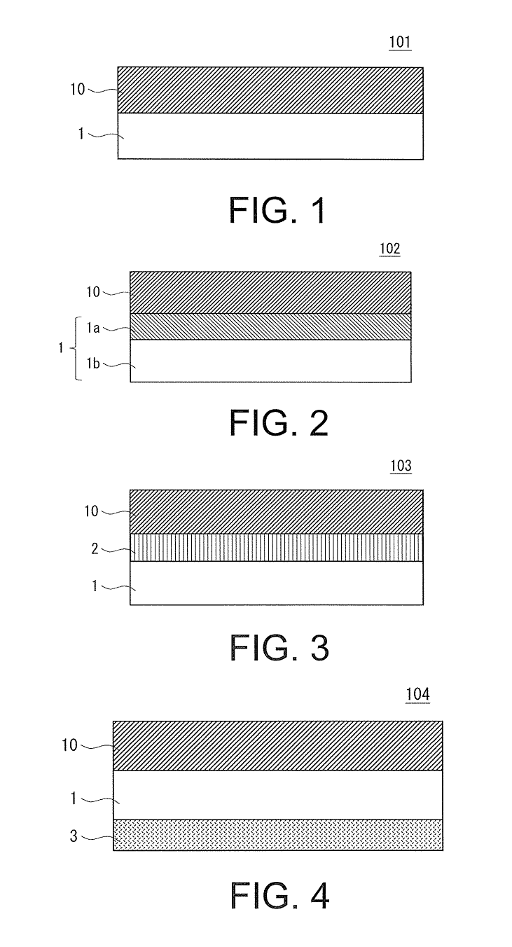

FIG. 1 shows decorative film 101 having a two-layer configuration of hard coat layer 10 and base material layer 1.

FIG. 2 shows decorative film 102 consisting of a laminate of hard coat layer 10 and 2 layers of first base material layer 1a and second base material layer 1b. The first base material layer 1a and the second base material layer 1b can be established by, for example, coextrusion.

FIG. 3 shows decorative film 103 having adhesive layer 2 sandwiched between hard coat layer 10 and base material layer 1.

FIG. 4 shows decorative film 104 having hard coat layer 10 and base material layer 1 and having colored layer 3 on a non-facing side of the base material layer 1 with respect to the hard coat layer 10.

FIG. 5 shows decorative film 105 having hard coat layer 10, base material layer 1, and colored layer 3 and consisting of a laminate of the colored layer 3 sandwiched between the hard coat layer 10 and the base material layer 1.

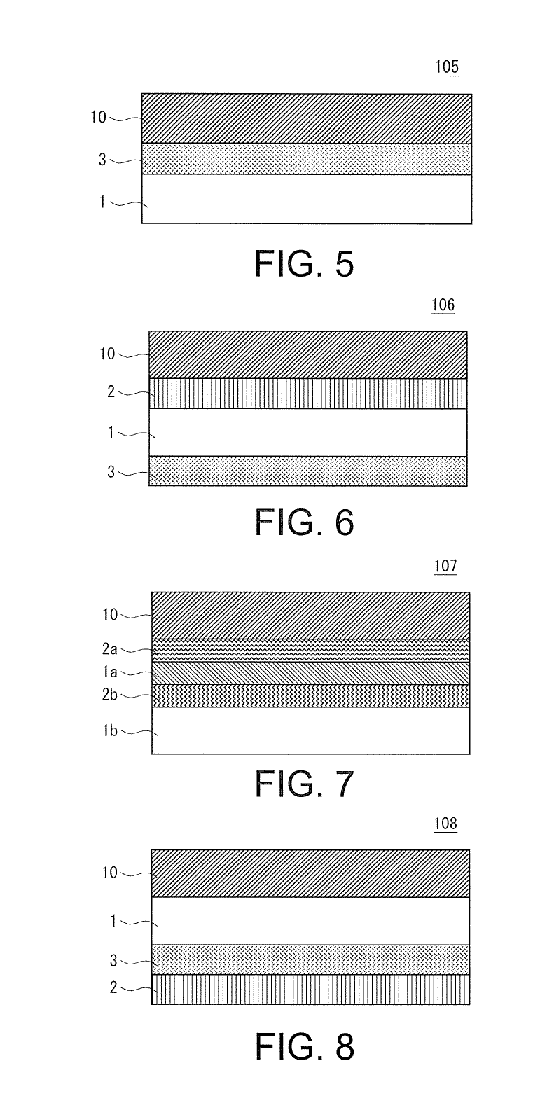

FIG. 6 shows decorative film 106 having hard coat layer 10, base material layer 1, adhesive layer 2, and colored layer 3, wherein the adhesive layer 2 is sandwiched between the hard coat layer 10 and the base material layer 1, and the colored layer 3 is located on a non-facing side of the base material layer 1 with respect to the adhesive layer 2.

FIG. 7 shows decorative film 107 having hard coat layer 10, first base material layer 1a, second base material layer 1b, first adhesive layer 2a, and second adhesive layer 2b, wherein the first adhesive layer 2a is positioned between the hard coat layer 10 and the first base material layer 1a, and the second adhesive layer 2b is positioned at the first base material layer 1a and the second base material layer 1b.

FIG. 8 shows a form having hard coat layer 10, base material layer 1, colored layer 3, and adhesive layer 2, wherein the colored layer 3 is positioned on a non-facing side of the base material layer 1 with respect to the hard coat layer 10, and the hard coat layer 10 and the adhesive layer 2 are respectively positioned on the surfaces.

### <Decorated Molded Article>

The decorated molded article of the present disclosure is a molded article or the like whose surface is covered with the decorative film. The material for the decoratable object to be covered is not particularly limited, and a material known in the art can be used.

Examples of the material that can be used as the decoratable object can include wood, paper, metals, plastics, fiber-reinforced plastics, rubbers, glass, minerals, and clay. One type or two or more types in combination can be used.

Examples of the plastics include polyethylene, polypropylene, polyvinyl chloride, polystyrene, polyurethane, epoxy resins, acrylonitrile-butadiene-styrene (ABS) resins, acrylonitrile-styrene (AS) resins, poly(meth)acrylate, polycarbonate, polyamide, polyimide, polyphenylene ether, polyphenylene sulfide, polyester, and polytetrafluoroethylene. One type or two or more types in combination can be used.

Examples of the fiber-reinforced plastics include carbon fiber-reinforced plastics, glass fiber-reinforced plastics, aramide fiber-reinforced plastics, and polyethylene fiber-reinforced plastics. One type or two or more types in combination can be used.

Examples of the metals include hot-rolled steel, cold-rolled steel, galvanized steel, electrogalvanized steel, hot-dip galvanized steel, alloyed hot-dip galvanized steel, zinc alloy-plated steel, copper-plated steel, zinc-nickel-plated steel, zinc-aluminum-plated steel, iron-zinc-plated steel, aluminum-plated steel, aluminum-zinc-plated steel, tin-plated steel, aluminum, stainless steel, copper, aluminum alloys, and electromagnetic steel. One type or two or more types in combination can be used. These metals may be provided on their surfaces with a rust inhibitor layer or the like.

A method for integrating the decorative film of the present disclosure with the decoratable object is not particularly limited, and they can be integrated by an integration method known in the art. For example, insert molding, in-mold molding, vacuum molding, pressure molding, TOM molding, or press molding can be used as the integration method.

For example, the decorative film of the present disclosure may be premolded into the desired shape and then injection-molded with a plastic or a fiber-reinforced plastic such that the hard coat layer side becomes an outermost layer to obtain the decorated molded article.

Alternatively, a molded article is obtained in advance from a plastic, a fiber-reinforced plastic, or a metal, and the decorative film of the present disclosure or a premolded article obtained by premolding the decorative film into the desired shape may be bonded to the surface of the molded article such that the hard coat layer side becomes an outermost layer to obtain the decorated molded article.

In the decorated molded article of the present disclosure, the hard coat layer side of the decorative film is positioned in an outermost layer. As mentioned above, the hard coat layer of the decorative film may be provided with a protective film for protection against poor appearance that may occur in each of steps such as coating, drying, aging, and integral molding. It is preferred that the protective film should be stripped when the obtained decorated molded article is used.

As a result of conducting diligent studies, the present inventors have found that a coating having high abrasion resistance and excellent sunscreen cream resistance is obtained by setting 56% or more of the hydroxy groups in the acrylic copolymer (A) to a primary hydroxy group. This is probably because cross-linking can proceed homogeneously within the coating under the condition described above.

According to the decorative film of the present disclosure, curing can proceed collectively, regardless of the shape or size of the decoratable object to be covered because a thermosetting coating, not a photocurable coating, is used. This leads to high versatility and excellent productivity. The decorative film of the present disclosure that satisfies the conditions (IV) to (VII) mentioned above by the acrylic copolymer and satisfies the conditions (I) to (III) mentioned above can not only achieve excellent moldability but has excellent design, abrasion resistance, and sunscreen cream resistance.

### EXAMPLES

Hereinafter, the present disclosure will be described in more detail with reference to Examples. However, the present disclosure is not limited by Examples given below. In Examples, the term “part” refers to part by mass, and the term “%” refers to % by mass (except for % as to the rate of elongation).

### Synthesis Example A-1 “Acrylic Copolymer A-1 Solution”

A four-neck flask equipped with a condenser, a stirring apparatus, a thermometer, and a nitrogen inlet tube was fed 150 parts of methyl isobutyl ketone (MIBK) and heated with stirring in a nitrogen atmosphere. After the internal temperature of the flask reached 74° C., this temperature was maintained as a synthesis temperature, and a mixed monomer solution of 3 parts of methyl methacrylate, 82.54 parts of n-butyl methacrylate, 12.85 parts of 4-hydroxybutyl acrylate, 0.61 parts of methacrylic acid, 1 part of Fancryl FA-711MM (manufactured by Hitachi Chemical Co., Ltd., pentamethylpiperidinyl methacrylate), and 0.1 parts of azobisisobutyronitrile was added dropwise thereto over 2 hours. The reaction was continued by the addition of 0.02 parts of azobisisobutyronitrile every 1 hour from 1 hour after the completion of the dropwise monomer addition and continued until unreacted monomers in the solution became 1% or less. After the unreacted monomers became 1% or less, the reaction was terminated by cooling to obtain an acrylic copolymer A-1 solution having approximately 40% solids. The acrylic copolymer A-1 had a glass transition temperature of 15° C., an acid value of 4 mgKOH/g, a hydroxy value of 50 mgKOH/g, a number-average molecular weight of 70,000, a weight-average molecular weight of 150,000, and a polydispersity index of 2.3.

The percent solids, the glass transition temperature (Tg), the acid value, the hydroxy value, the number-average molecular weight (Mn), the weight-average molecular weight (Mw), and the polydispersity index (Mw/Mn) were measured by the methods described below.

### <<Percent Solid Measurement>>

The mass of an aluminum dish with a lid having a diameter of 55 mm and a depth of 15 mm is measured to 4 decimal places. Approximately 1.5 g of a resin solution is collected into the aluminum dish, which is immediately covered with the lid. The mass is measured rapidly and accurately. The lid is removed, and in this state, the aluminum dish is placed in an oven of 150° C. and dried for 10 minutes. After cooling to room temperature, the masses of the aluminum dish and the lid are measured. The percent solids are calculated according to the following expression.

Percent solids (%)=(Mass after the drying−Mass of the aluminum dish)/(Mass before the drying−Mass of the aluminum dish)×100

### <<Measurement of Glass Transition Temperature (Tg)>>

An aluminum pan containing approximately 10 mg of a resin sample having 100% solids by the drying of the solvent, or an aluminum pan containing no sample is loaded in a differential scanning calorimetry (DSC) apparatus and subjected to cooling treatment up to a temperature of 50° C. minus the predicted glass transition temperature using liquid nitrogen in a nitrogen stream. Then, the aluminum pan is heated to a temperature of 50° C. plus the predicted glass transition temperature at a heating rate of 10° C./min. A DSC curve is plotted. Based on this DSC curve, an extrapolated glass transition onset temperature (Tig) is determined from the intersection of a straight line extended from the baseline on the lower temperature side (DSC curve area in a temperature region without transition and reaction in the test specimen) to the higher temperature side and a tangent taken at the point of the maximum slope in an area with step-like change in glass transition. This temperature was used as the glass transition temperature.

### <<Measurement of Acid Value (AV)>>

Approximately 1 g of a resin solution is precisely weighed into a stoppered Erlenmeyer flask and dissolved by the addition of 50 mL of a toluene/ethanol (volume ratio: toluene/ethanol=2/1) mixed solution. A phenolphthalein reagent is added thereto as an indicator, and the solution is retained for 30 seconds. Then, the solution is titrated with a 0.1 mol/L alcoholic potassium hydroxide solution until assuming a rose-pink color. The acid value was determined according to the expression given below. The acid value was a numerical value in a dry state of the resin.

Acid value (mgKOH/g)=(a×F×56.1×0.1)/S

S: Amount of the sample collected×(Percent solids of the sample/100) (g)
a: Titrated amount with the 0.1 mol/L alcoholic potassium hydroxide solution (mL)
F: Titer of the 0.1 mol/L alcoholic potassium hydroxide solution

### <<Measurement of Hydroxy Value (OHV)>>

Approximately 1 g of a resin solution is precisely weighed into a stoppered Erlenmeyer flask and dissolved by the addition of 50 mL of a toluene/ethanol (volume ratio: toluene/ethanol=2/1) mixed solution. Accurately 5 mL of an acetylating agent (solution containing 25 g of acetic anhydride dissolved in pyridine and adjusted to a volume of 100 mL) is further added thereto, and the solution is heated to 100° C. and stirred for approximately 1 hour. A phenolphthalein reagent is added thereto as an indicator, and the solution is retained for 30 seconds. Then, the solution is titrated with a 0.5 mol/L alcoholic potassium hydroxide solution until assuming a rose-pink color. Aside from this, for a blank test, an acetylating agent is added to a toluene/ethanol mixed solution alone, and the solution is heated at 100° C. for 1 hour and titrated with a 0.5 mol/L alcoholic potassium hydroxide solution. The hydroxy value was determined according to the expression given below. The hydroxy value was a numerical value in a dry state of the resin.

Hydroxy value(mgKOH/g)={(b−a)×F×56.1×0.5}/S+D

S: Amount of the sample collected×(Percent solids of the sample/100) (g)
a: Titrated amount with the 0.5 mol/L alcoholic potassium hydroxide solution (mL)
b: Titrated amount with the 0.5 mol/L alcoholic potassium hydroxide solution (mL) in the blank test
F: Titer of the 0.5 mol/L alcoholic potassium hydroxide solution
D: Acid value (mgKOH/g)

### <<Measurement of Number-Average Molecular Weight (Mn) and Weight-Average Molecular Weight (Mw)>>

These molecular weights were measured using Shodex GPC-104/101 system manufactured by Showa Denko K.K.

### Colum: Shodex KF-805L+KF-803L+KF-802

Detector: refractive index meter (RI)
Column temperature: 40° C.
Eluent: tetrahydrofuran (THF)
Flow rate: 1.0 mL/min
Sample concentration: 0.2%
Standard sample for calibration curve: TSK standard polystyrene

From the obtained Mn and Mw, the polydispersity index was determined according to the following expression.

Polydispersity index=Mw/Mn

### Synthesis Examples A-2 to A-45 “Acrylic Copolymer A-2 to A-45 Solutions”

Acrylic copolymer A-2 to A-45 solutions were obtained through reaction according to the composition of Tables 1 to 4. Their glass transition temperatures, acid values, hydroxy values, number-average molecular weights, weight-average molecular weights, and polydispersity indexes are shown in Tables 1 to 4. The percent solids were adjusted to 40% for all the solutions. The symbols in the tables are as follows.

MMA: methyl methacrylate
MAA: methacrylic acid
CHMA: cyclohexyl methacrylate
BA: n-butyl acrylate
n-BMA: n-butyl methacrylate
2-EHMA: 2-ethylhexyl methacrylate
2-HEMA: 2-hydroxyethyl methacrylate
4-HBA: 4-hydroxybutyl acrylate
GLMA: glyceryl methacrylate
FA-711MM: pentamethylpiperidinyl methacrylate
FA-712HM: tetramethylpiperidinyl methacrylate
2,3-DHMA: 2,3-dihydroxybutyl methacrylate
AIBN: azobisisobutyronitrile

“Content percentage of monomer having one hydroxy group” in Tables 1 to 4 refers to the content percentage of the monomer having one hydroxy group in the compound in 100% by mol of the monomers having hydroxy group(s), constituting the acrylic copolymer (A). “Ratio of primary OH group” in these tables refers to the ratio of the primary hydroxy group to the hydroxy groups in the acrylic copolymer (A).

### Synthesis Example A′-101 for Comparative Example “Acrylic Copolymer A′-101 Solution”

A four-neck flask equipped with a condenser, a stirring apparatus, a thermometer, and a nitrogen inlet tube was fed 100 parts of ethyl acetate and heated to 77° C. with stirring in a nitrogen atmosphere. After the internal temperature of the flask reached 77 parts, a mixed monomer solution of 10 parts of methyl methacrylate, 86 parts of n-butyl methacrylate, 2 parts of 2-hydroxyethyl methacrylate, 2 parts of 2-hydroxybutyl methacrylate, and 0.04 parts of azobisisobutyronitrile was added dropwise thereto over 2 hours. The reaction was continued by the addition of 0.02 parts of azobisisobutyronitrile every 1 hour from 1 hour after the completion of the dropwise monomer addition and continued until unreacted monomers in the solution became 1% or less. After the unreacted monomers became 1% or less, the reaction was terminated by cooling to obtain an acrylic copolymer A′-101 solution having approximately 50% solids. The acrylic copolymer A′-101 had a glass transition temperature of 28° C., an acid value of 0 mgKOH/g, a hydroxy value of 16 mgKOH/g, a number-average molecular weight of 145,000, a weight-average molecular weight of 450,000, and a polydispersity index of 3.1 (see Table 5).

The symbols in Table 5 are as described about Tables 1 to 4 or as follows.

2-HBMA: 2-hydroxybutyl methacrylate
2,3-DHPM: 2,3-hydroxypropyl methacrylate

### Synthesis Example A′-102 for Comparative Example “Acrylic Copolymer A′-102 Solution”

An acrylic copolymer A′-102 solution was obtained by synthesis in the same way as in Synthesis Example A′-101 for Comparative Example according to the composition shown in Table 5.

The acrylic copolymer A′-102 had a glass transition temperature of 28° C., an acid value of 0 mgKOH/g, a hydroxy value of 19 mgKOH/g, a number-average molecular weight of 52,000, a weight-average molecular weight of 150,000, and a polydispersity index of 2.9.

### Synthesis Example A′-103 for Comparative Example “Acrylic Copolymer A′-103 Solution”

A four-neck flask equipped with a condenser, a stirring apparatus, a thermometer, and a nitrogen inlet tube was fed 40 parts of methyl methacrylate, 30 parts of n-butyl methacrylate, 20 parts of 2-ethylhexyl methacrylate, 10 parts of 2-hydroxyethyl methacrylate, and 100 parts of toluene and heated to 80° C. with stirring in a nitrogen atmosphere. 0.08 parts of azobisisobutyronitrile were added thereto, and polymerization reaction was performed for 2 hours. Next, 0.07 parts of azobisisobutyronitrile were added thereto, and polymerization reaction was further performed for 2 hours. 0.07 parts of azobisisobutyronitrile were further added thereto, and polymerization reaction was further performed for 2 hours to obtain an acrylic copolymer A′-103 solution having approximately 50% solids. The acrylic copolymer A′-103 had a glass transition temperature of 24° C., an acid value of 0 mgKOH/g, a hydroxy value of 35.5 mgKOH/g, a number-average molecular weight of 75,000, a weight-average molecular weight of 165,000, and a polydispersity index of 2.2.

### Synthesis Example A′-104 for Comparative Example “Acrylic Copolymer A′-104 Solution”

A four-neck flask equipped with a condenser, a stirring apparatus, a thermometer, and a nitrogen inlet tube was fed 6.7 parts of methyl methacrylate, 63.9 parts of n-butyl methacrylate, 0.6 parts of methacrylic acid, 27.8 parts of 2-hydroxyethyl methacrylate, 1 part of Fancryl FA-711MM (manufactured by Hitachi Chemical Co., Ltd., pentamethylpiperidinyl methacrylate), and 500 parts of propylene glycol 1-monomethyl ether 2-acetate and heated to 100° C. with stirring in a nitrogen atmosphere. Subsequently, 2.5 parts of azobisisobutyronitrile were added thereto, and polymerization reaction was performed for 2 hours. Subsequently, polymerization reaction was performed by the addition of 0.5 parts of azobisisobutyronitrile every 1 hour until the rate of conversion became 98% or more. After confirmation that the rate of conversion was 98% or more, the reaction solution was diluted with 250 parts of propylene glycol 1-monomethyl ether 2-acetate to obtain an acrylic copolymer A′-103 solution having approximately 40% solids.

The acrylic copolymer A′-104 had a glass transition temperature of 34° C., an acid value of 4 mgKOH/g, a hydroxy value of 120 mgKOH/g, a number-average molecular weight of 18,000, a weight-average molecular weight of 210,000, and a polydispersity index of 12.

### Synthesis Examples A′-105 to A′-109 for Comparative Examples “Acrylic Copolymer A′-105 to A′-109 Solutions”

Acrylic copolymer A′-105 to A′-109 solutions were obtained through the same reaction as in Synthesis Example A-1 according to the composition of Table 5. Their glass transition temperatures, acid values, hydroxy values, number-average molecular weights, weight-average molecular weights, and polydispersity indexes are shown in Table 5. The percent solids were adjusted to 40% for all the solutions.

### Synthesis Example A′-110 for Comparative Example “Acrylic Copolymer A′-110 Solution”

A four-neck flask equipped with a condenser, a stirring apparatus, a thermometer, and a nitrogen inlet tube was fed 70 parts of methyl isobutyl ketone and 20 parts of methyl methacrylate and heated to 80° C. Then, a mixed solution containing 73.5 parts of methyl methacrylate, 1 part of butyl methacrylate, 5 parts of 2-hydroxyethyl methacrylate, 0.5 parts of methacrylic acid and 0.3 parts of azobisisobutyronitrile uniformly dissolved and stirred was added dropwise thereto over 2 hours, followed by incubation at 80° C. for 2 hours. Then, a mixed solution containing 75 parts of methyl isobutyl ketone and 0.5 parts of azobisisobutyronitrile uniformly dissolved and stirred was added dropwise thereto over 1 hour, followed by incubation at 80° C. for 4 hours. Then, the solution was cooled to 50° C., and 88.3 parts of methyl isobutyl ketone were added thereto to obtain an acrylic copolymer A′-110 solution having approximately 30% solids.

The acrylic copolymer A′-110 had a glass transition temperature of 101° C., an acid value of 3.25 mgKOH/g, a hydroxy value of 20 mgKOH/g, a number-average molecular weight of 29,000, a weight-average molecular weight of 130,000, and a polydispersity index of 4.5.

### Synthesis Example A′-111 for Comparative Example “Acrylic Copolymer A′-111 Solution”

An acrylic copolymer A′-111 solution was obtained through the same reaction as in Synthesis Example A-1 according to the composition of Table 5. Its glass transition temperature, acid value, hydroxy value, number-average molecular weight, weight-average molecular weight, and polydispersity index are shown in Table 5. The percent solids were adjusted to 40%.

Liquid Preparation of Coating Material “HC-1” for Hard Coats and Preparation of Cured Coating

To the acrylic copolymer (A-1) solution obtained in Synthesis Example 1 containing 100 parts by mass (solids) of the acrylic copolymer (A-1), 59.9 parts by mass (solid mass) of a polyisocyanate compound DURANATE “P301-75E” (manufactured by Asahi Kasei Chemicals Corp., polyisocyanate form of hexamethylene diisocyanate; hereinafter, referred to as curing agent 1) were added, further methyl isobutyl ketone (MIBK) was added so as to attain 30% solids, and the mixture was stirred to obtain a coating material (HC-1) for hard coats.

The coating material (HC-1) for hard coats was applied using a doctor blade onto the stripping side of a polyethylene terephthalate (PET) film subjected to stripping treatment in advance, and dried in an oven of 100° C. for 1 minute to volatilize the solvents. The doctor blade was selected such that the film thickness after the drying was 50 μm. Subsequently, the resultant was left in a temperature-controlled room of 50° C. for 4 days so that the reaction of the acrylic copolymer with the polyisocyanate compound proceeded (aging) to form a cured coating on the strippable PET film.

The total light transmittance, the diffuse transmittance, the yield value, and the rate of elongation of the obtained cured coating were determined according to the methods mentioned later.

Liquid Preparation of Coating Materials “HC-1 to HC-54” for Hard Coats and Preparation of Cured Coatings

Coating materials (HC-2 to HC-54) for hard coats were obtained in the same way as in the coating material HC-1 for hard coats according to the composition shown in Tables 6 and 7.

Curing agent 2 (represented by 2 in “Type” of the curing agent in Tables 6 and 7) was “MHG-80B” manufactured by Asahi Kasei Chemicals Corp., a polyisocyanate form of hexamethylene diisocyanate and 3-isocyanatomethyl-3,5,5-trimethylcyclohexyl isocyanate. The polyol used in HC-51 to HC-54 is Kuraray Polyol P-6010 manufactured by Kuraray Co., Ltd.

### Example 101

The coating material (HC-1) for hard coats was applied using a doctor blade onto one side of an A4-size polycarbonate base material having a thickness of 300 μm (manufactured by Bayer AG, Makrofol, DE1-1) and dried in an oven of 100° C. for 1 minute to volatilize the solvents. The doctor blade was selected such that the film thickness after the drying was 20 m.

Subsequently, the resultant was left in a temperature-controlled room of 50° C. for 4 days so that the reaction of the acrylic copolymer with the polyisocyanate compound proceeded (aging) to obtain a decorative film having a hard coat layer formed on the Polycarbonate base material.

The decorative film was evaluated for its adhesion, solvent resistance, pencil hardness, abrasion resistance, moldability, sunscreen cream resistance, and weather resistance according to the methods mentioned later. The results are shown in Table 8.

### Examples 102 to 154

Decorative films were prepared in the same way as in Example 101 using the coating materials (HC-2 to HC-54) for hard coats according to Tables 8 and 9 and evaluated in the same way as therein. The results are shown in Tables 8 and 9.

### Example 201

The PMMA resin layer side of TECHNOLLOY C001 (manufactured by Escarbo Sheet Co., Ltd., PMMA resin layer/PC resin layer two-layer sheet, total thickness: 300 μm) was coated with the coating material (HC-1) for hard coats using a doctor blade. The doctor blade was selected such that the film thickness after drying was 20 m. The sheet thus coated was left in an oven of 100° C. for 1 minute to volatilize the solvents. Subsequently, the resultant was left in a temperature-controlled room of 50° C. for 4 days so that the reaction of the acrylic copolymer with the polyisocyanate compound proceeded (aging) to obtain a decorative film. The decorative film was evaluated in the same way as in Example 101 according to the methods mentioned later. The results are shown in Table 10.

### Examples 202 to 254

Decorative films were prepared in the same way as in Example 201 using the coating materials (HC-2 to HC-54) for hard coats according to Tables 10 and 11 and evaluated in the same way as therein. The results are shown in Tables 10 and 11.

### Example 301

A strippable PET film was coated with the coating material (HC-1) for hard coats by the method mentioned above, followed by drying and curing to form a cured coating having a thickness of 50 μm.

Next, a laminate adhesive (manufactured by Toyo Morton, Ltd., TOMOFLEX TM-K51/CAT-56) was applied onto the non-deposited side of a PET film (thickness: 50 μm) indium-deposited on one side, so as to attain a dry film thickness of 5 μm. Next, the cured resin coating layer was peeled off from the strippable PET film, while its side in no contact with the strippable PET film was overlaid in contact with the laminate adhesive on the indium-deposited PET film and laminated under pressure bonding conditions of a nip temperature of 80° C. and a nip pressure of 15 kg/cm. The laminate was left in a temperature-controlled room of 50° C. for 4 days so that the reaction of the laminate adhesive proceeded (aging) to obtain a decorative film. The decorative film was evaluated in the same way as in Example 101 according to the methods mentioned later. The results are shown in Table 12.

### Examples 302 to 354

Decorative films were prepared in the same way as in Example 301 using the coating materials (HC-2 to HC-54) for hard coats according to Tables 12 and 13 and evaluated in the same way as therein. The results are shown in Tables 12 and 13.

### Comparative Example 1

To the acrylic copolymer (A′-101) solution obtained in Synthesis Example A′-101 for Comparative Example containing 100 parts by mass of the acrylic copolymer (A′-101), 59.9 parts by mass (solid mass) of a polyisocyanate compound P301-75E (manufactured by Asahi Kasei Chemicals Corp., polyisocyanate compound; hereinafter, referred to as curing agent 1 (represented by 1 in “Type” of the curing agent in Tables 6 and 7)) were added, further methyl isobutyl ketone (MIBK) was added so as to attain 30% solids, and the mixture was stirred to obtain a coating material (HC′-1).

The total light transmittance, the diffuse transmittance, the yield value, and the rate of elongation of a cured coating obtained from the obtained coating material were determined in the same way as the methods mentioned above.

The obtained coating material was also evaluated for its adhesion, solvent resistance, pencil hardness, abrasion resistance, moldability, sunscreen cream resistance, and weather resistance in the same way as in Examples. The results are shown in Table 14.

### Comparative Examples 2 to 10 and 13

Coating materials were obtained in the same way as in Comparative Example 1 according to the composition shown in Table 14. Then, decorative films were prepared in the same way as in Comparative Example 1 and evaluated in the same way as therein. The results are shown in Table 14.

### Comparative Example 11

To the acrylic copolymer (A′-110) solution obtained in Synthesis Example A′-110 for Comparative Example containing 100 parts by mass of the acrylic copolymer (A′-110), 16.7 parts by mass (solid mass) of a polyisocyanate compound E405-70B (manufactured by Asahi Kasei Chemicals Corp., polyisocyanate compound) (represented by 3 in “Type” of the curing agent in Table 14) were added, further 100 parts of HITALOID 7903-3 (manufactured by Hitachi Chemical Co., Ltd., polyfunctional urethane acrylate, 50% solids, butyl acetate solution product) and 4 parts by mass of a photo radical initiator IRGACURE 184 (manufactured by Ciba Specialty Chemicals Corp., 1-hydroxy-cyclohexyl-phenyl-ketone) were added so as to 50 parts by mass of a photocurable prepolymer with respect to 100 parts by mass of the acrylic copolymer (A′-110), and the mixture was stirred to obtain a coating material.

A decorative film was prepared in the same way as in Example 1 using the obtained coating material and evaluated in the same way as therein.

### Comparative Example 12

A base material was coated with the coating material obtained in Comparative Example 11 in the same way as in Comparative Example 11, dried at 100° C. for 1 minute, and then irradiated with active energy at a fluence of 200 mJ/cm² using a high-pressure mercury lamp of 80 W/cm to obtain a coating, which was evaluated in the same way as in Comparative Example 1.

### <<Measurement of Total Light Transmittance and Diffuse Transmittance>>

The hard coat layer disposed on the PET film subjected to stripping treatment was isolated, and the total light transmittance and the diffuse transmittance were measured using a haze meter NDH2000 manufactured by Nippon Denshoku Industries, Co., Ltd.

### <<Measurement of Yield Value and Rate of Elongation>>

The hard coat layer disposed on the PET film subjected to stripping treatment was isolated, and cut into strips having a width of 10 mm. The strip specimen was subjected to a tensile test in an atmosphere of 25° C. and 50% RH in a “TENSILON universal tester RTE-1210 manufactured by TENSILON.

Pulling speed: 0.5 mm/min
Sample size: 5 mm in width×approximately 0.1 mm in thickness
Inter-chuck distance: 10 mm
Tensile strength (yield value): N/mm²

A value immediately before break was used as the rate of elongation, and a value described below was used as the yield value. The isolated hard coat layer is pulled by the application of force, and a stress-strain curve is drawn. In this case, the strain first exhibits a constant slope against the stress. Once the stress reaches a certain point, the strain exhibits increase whereas the stress is decreased. In this respect, the film is regarded as yielding. The stress at this point is called “yield value” and was used as the tensile strength according to the present disclosure.

### <<Adhesion>>

The adhesion on the hard coat layer side of the obtained decorative film was tested by the cross-hatch, tape-peeling method in accordance with JIS K-5400, and indicated by the number of grids remaining in 100 grids of the coating.

### <<Solvent Resistance>>

A solvent resistance test was conducted on the hard coat layer side of the obtained decorative film. A swab is impregnated with methyl ethyl ketone (MEK) and shuttled at a width of 3 cm on the acrylic resin layer by the application of force without breaking the swab. Change in the surface of the acrylic resin layer was evaluated.

4: No change was seen in the surface of the acrylic resin layer even after 100 shuttles.
3: The surface of the acrylic resin layer was slightly cloudy after 100 shuttles.
2: The surface of the acrylic resin layer was cloudy by 50 shuttles.
1: The acrylic resin layer peeled away and exposed the sheet-like base material by 100 shuttles.

### <<Pencil Hardness>>

The pencil hardness was measured as the surface hardness of the decorative film. In accordance with JIS K5400, the decorative film containing the polycarbonate base material was cut into 80 mm×60 mm, and lines were drawn on the surface on the acrylic resin layer side using a cylindrical pencil under a load of 1 kg in a temperature-controlled room having an atmospheric temperature of 23° C. such that the angle of the edge of the pencil tip shaved flat was kept at 45 degrees. The surface scratch was evaluated. For example, five lines are drawn using a H pencil, and the pencil hardness of a sample scratched within two out of the five lines is indicated by H. When a sample is scratched at 3 out of the five lines, the test is conducted again using a F pencil, and the pencil hardness is indicated by the hardness of the pencil that generates scratches within 2 lines.

### <<Evaluation of Abrasion Resistance>>

The abrasion resistance of the decorative film was tested in accordance with JIS K7204 and K6264 [Abrasion Test] and evaluated on the basis of the criteria given below. The decorative film used in the test was the decorative film containing the polycarbonate base material. The apparatus used in the test was “Rotary Abrasion Tester” manufactured by Toyo Seiki Seisaku-sho, Ltd. “CS-10” was used as the theory of wear. The volume of wear after 500 rotations under a load of 500 g was evaluated. The evaluation criterial are as follows.

4: The volume of wear was less than 5 mg.
3: The volume of wear was 5 mg or more and less than 20 mg.
2: The volume of wear was 20 mg or more and less than 50 mg.
1: The volume of wear was 50 mg or more.

### <<Evaluation of Moldability>>

The decorative film is loaded in the middle of a vacuum molding machine divided into two chamber boxes (upper and lower) such that the hard coat layer turns up. A molding die is loaded in the lower chamber box. The molding die used was a tray-shaped die for deep draw molding having a size of 80 mm square, a 10 mm depth, and 3R corners. Next, a vacuum state is created within the chamber boxes using a vacuum pump. A heater above the chambers is switched on, and heating is continued until the surface temperature of the decorative film reaches 160° C. After the decorative film is thermally softened to sag, the die in the lower chamber box is moved upward to cover the die with the decorative film.

Next, the upper chamber box is rendered open to the atmosphere. The decorative film adheres to the die by the difference in atmospheric pressure. Compressed air is injected to the upper chamber box so that the decorative film adheres to the die by larger force. The lower chamber box is brought back to the atmospheric pressure state, and the upper chamber box is moved upward and cooled. Then, the premolded product is retrieved from the die. The obtained molded decorative film was evaluated for its appearance (moldability) according to the following criteria.

4: Neither wrinkles nor chips were present.
3: Although neither wrinkles nor chips were present, partial uplift was seen.
2: Wrinkles or chips were seen in 10% of the whole.
1: Wrinkles or chips were seen in 50% or more of the whole.

### <<Evaluation of Sunscreen Cream Resistance>>

0.5 g of a sunscreen cream (Neutrogena Ultra Sheer DRY-TOUCH SUNSCREEN SPF55 (manufactured by Johnson & Johnson K.K.)) is applied onto the hard coat layer of the decorative film, and a glass sheet is placed thereon. A load of 500 g is further placed on the glass sheet to let the sunscreen cream spread. In this state, the sample is left at 80° C. for 24 hours. The sunscreen cream is washed off from the sample thus left with water, and the sample is drained. Then, the appearance in the range of a circle of 3 cm in diameter centered on the sunscreen cream-dropped portion was visually observed and evaluated according to the following criteria.

4: Poor appearance such as wrinkle generation or discoloration was seen neither in the hard coat layer nor in the base material layer.
3: Although a portion (10% or less of the area) of the hard coat layer uplifted from the base material layer, no discoloration was seen in the base material layer.
2: A portion (10% or less of the area) of the hard coat layer uplifted from the base material layer, and furthermore, discoloration was also seen in the base material layer.
1: The hard coat layer uplifted in a range exceeding 10% of the area from the base material layer, or discoloration was seen in the base material layer in a range exceeding 10% of the area.

### <<Weather Resistance Test: Change in Gloss>>

The hard coat layer side of the obtained decorative film was subjected to a weather resistance test under the following conditions using the following accelerated weather resistance tester.

Super Xenon Weather Meter SX75 manufactured by Suga Test Instruments Co., Ltd.
Xenon long-life arc lamp 7.5 kW (ultraviolet region: 300 to 400 nm)

### Irradiation+raining 38° C., 95% RH, 160 W/m², 12 min

Irradiation 63° C., 50% RH, 160 W/m², 1 hour and 48 minutes
Repeated 100 times: the weather resistance test was conducted for a total of 1600 hours by 8 cycles each involving 200 hours.

The gloss value on the hard coat layer side was measured before and after the test using the following glossmeter, and the weather resistance was evaluated from the difference between the gloss value before the test and the gloss value after the test.

3 sites in the test specimen were measured at incidence and reflection angles of 60 degrees using Micro-Tri-Gloss glossmeter manufactured by BYK-Gardner GmbH, and an average value was determined.

Change in gloss (%)=(Gloss value after the test−Gloss value before the test)/Gloss value before the test×100

4: The change in gloss between before and after the test was less than 10%.
3: Change in gloss after the test was 10% or more and less than 20%.
2: Change in gloss after the test was 20% or more and less than 30%.
1: Change in gloss after the test was 40% or more.

TABLE 1

| | Synthesis Example | | | | | | | | | | |
|---|---|---|---|---|---|---|---|---|---|---|---|
| | A-1 | A-2 | A-3 | A-4 | A-5 | A-6 | A-7 | A-8 | A-9 | A-10 | A-11 |
| MMA | 3 | 10 | 17 | 8 | 5 | 2 | 35 | 32 | 28 | | |
| CHMA | | | | | | | | | | 79 | 80 |
| n-BMA | 82.54 | 67.83 | 53.12 | 78.8 | 74.85 | 70.9 | 51.81 | 47.85 | 44.9 | 14.76 | 15.39 |
| 2-EHMA | | | | | | | | | | | |
| MAA | 0.61 | 0.61 | 0.61 | 0.61 | 0.61 | 0.61 | 0.61 | 0.61 | 0.61 | 0.61 | 0.61 |
| 2-HEMA | | | | 11.59 | 18.54 | 25.49 | 11.58 | 18.54 | 25.49 | 4.63 | 3 |
| 4-HBA | 12.85 | 20.56 | 28.27 | | | | | | | | |
| FA-711MM | 1 | 1 | 1 | 1 | 1 | 1 | 1 | 1 | 1 | 1 | 1 |
| AIBN | 0.1 | 0.1 | 0.1 | 0.08 | 0.08 | 0.08 | 0.08 | 0.08 | 0.08 | 0.08 | 0.08 |
| Synthesis | 74 | 75 | 77 | 77 | 78 | 79 | 77 | 78 | 81 | 77 | 76 |
| temperature (° C.) | | | | | | | | | | | |
| OH value | 50 | 80 | 110 | 50 | 80 | 110 | 50 | 80 | 110 | 20 | 13 |
| (mgKOH/g) | | | | | | | | | | | |
| Acid value | 4 | 4 | 4 | 4 | 4 | 4 | 4 | 4 | 4 | 4 | 4 |
| (mgKOH/g) | | | | | | | | | | | |
| Tg (° C.) | 15 | 15 | 15 | 30 | 30 | 30 | 50 | 50 | 50 | 70 | 80 |
| Mn | 70000 | 70000 | 70000 | 70000 | 70000 | 80000 | 70000 | 80000 | 70000 | 70000 | 80000 |
| Mw | 150000 | 180000 | 260000 | 240000 | 320000 | 420000 | 270000 | 330000 | 440000 | 250000 | 240000 |
| Mw/Mn | 2.3 | 2.5 | 3.8 | 3.5 | 4.5 | 5.1 | 3.9 | 4.3 | 5.9 | 3.5 | 3.1 |
| content | 100% | 100% | 100% | 100% | 100% | 100% | 100% | 100% | 100% | 100% | 100% |
| percentage | | | | | | | | | | | |
| of monomer | | | | | | | | | | | |
| having one | | | | | | | | | | | |
| hydroxy group | | | | | | | | | | | |
| ratio of | 100% | 100% | 100% | 100% | 100% | 100% | 100% | 100% | 100% | 100% | 100% |
| primary | | | | | | | | | | | |
| OH group | | | | | | | | | | | |

TABLE 2

| | Synthesis Example | | | | | | | | | | |
|---|---|---|---|---|---|---|---|---|---|---|---|
| | A-12 | A-13 | A-14 | A-15 | A-16 | A-17 | A-18 | A-19 | A-20 | A-21 | A-22 |
| MMA | | | 64.8 | 62.52 | 61.21 | 60 | 59 | 39 | 84 | 50 | 37 |
| CHMA | 31 | 26.27 | | | | | | | | | |
| n-BMA | | | 32.33 | 32.33 | 31.33 | 30.22 | 28.9 | 55.85 | 10.85 | 42.54 | 53.22 |
| 2-EHMA | 29.98 | 31 | | | | | | | | | |
| MAA | 0.61 | 0.61 | 0.77 | 0.77 | 0.77 | 0.77 | 0.77 | 0.77 | 0.77 | 0.77 | 0.77 |
| 2-HEMA | | | 1.2 | 3.48 | 5.79 | 8.11 | 10.43 | 3.48 | 3.48 | 5.79 | 8.11 |
| 4-HBA | 37.41 | 41.12 | | | | | | | | | |
| FA-711MM | 1 | 1 | 0.9 | 0.9 | 0.9 | 0.9 | 0.9 | 0.9 | 0.9 | 0.9 | 0.9 |
| AIBN | 0.06 | 0.05 | 0.08 | 0.08 | 0.07 | 0.07 | 0.06 | 0.05 | 0.04 | 0.06 | 0.06 |
| Synthesis | 76 | 88 | 75 | 76 | 78 | 77 | 79 | 83 | 85 | 78 | 78 |
| temperature (° C.) | | | | | | | | | | | |
| OH value | 130 | 160 | 5 | 15 | 25 | 35 | 45 | 15 | 15 | 25 | 35 |
| (mgKOH/g) | | | | | | | | | | | |
| Acid value | 4 | 4 | 5 | 5 | 5 | 5 | 5 | 5 | 5 | 5 | 5 |
| (mgKOH/g) | | | | | | | | | | | |
| Tg (° C.) | 5 | 0 | 70 | 70 | 70 | 70 | 70 | 50 | 90 | 60 | 50 |
| Mn | 90000 | 90000 | 70000 | 70000 | 70000 | 80000 | 70000 | 100000 | 100000 | 80000 | 80000 |
| Mw | 700000 | 850000 | 200000 | 200000 | 300000 | 300000 | 400000 | 600000 | 800000 | 400000 | 400000 |
| Mw/Mn | 7.4 | 9.5 | 2.7 | 3.0 | 4.1 | 3.9 | 5.5 | 6.2 | 8.2 | 5.0 | 4.9 |
| content | 100% | 100% | 100% | 100% | 100% | 100% | 100% | 100% | 100% | 100% | 100% |
| percentage | | | | | | | | | | | |
| of monomer | | | | | | | | | | | |
| having one | | | | | | | | | | | |
| hydroxy group | | | | | | | | | | | |
| ratio of | 100% | 100% | 100% | 100% | 100% | 100% | 100% | 100% | 100% | 100% | 100% |
| primary | | | | | | | | | | | |
| OH group | | | | | | | | | | | |

TABLE 3

| | Synthesis Example | | | | | | |
|---|---|---|---|---|---|---|---|
| | A-23 | A-24 | A-25 | A-26 | A-27 | A-28 | A-29 |
| MMA | 20.16 | 15.89 | 10.31 | 5.00 | — | 30.00 | 30.00 |
| CHMA | — | — | — | — | — | — | 30.00 |
| n-BMA | 76.01 | 71.01 | 65.01 | 58.73 | 38.32 | 45.32 | 15.32 |
| BA | — | — | — | — | — | — | — |
| 2-EHMA | — | — | — | — | 37.00 | — | — |
| MAA | 0.61 | 0.61 | 0.61 | 0.61 | 0.61 | 0.61 | 0.61 |
| 2-HEMA | 2.32 | 11.59 | 23.17 | 34.76 | 23.17 | 23.17 | 23.17 |
| FA-711MM | 0.90 | 0.90 | 0.90 | 0.90 | 0.90 | — | — |
| FA-712HM | — | — | — | — | — | 0.90 | 0.90 |
| AIBN | 0.12 | 0.10 | 0.08 | 0.07 | 0.08 | 0.08 | 0.08 |
| Synthesis | 80 | 80 | 80 | 80 | 80 | 80 | 80 |
| temperature (° C.) | | | | | | | |
| OH value | 10 | 50 | 100 | 150 | 100 | 100 | 100 |
| (mgKOH/g) | | | | | | | |
| Acid value | 4 | 4 | 4 | 4 | 4 | 4 | 4 |
| (mgKOH/g) | | | | | | | |
| Tg (° C.) | 35 | 35 | 35 | 35 | 15 | 50 | 70 |
| Mn | 60000 | 70000 | 80000 | 90000 | 80000 | 80000 | 90000 |
| Mw | 150000 | 250000 | 400000 | 600000 | 400000 | 400000 | 350000 |
| Mw/Mn | 2.5 | 3.8 | 5.0 | 6.9 | 4.9 | 4.8 | 4.1 |
| content percentage | 100% | 100% | 100% | 100% | 100% | 100% | 100% |
| of monomer having | | | | | | | |
| one hydroxy group | | | | | | | |
| ratio of primary OH | 100% | 100% | 100% | 100% | 100% | 100% | 100% |
| group | | | | | | | |

| | Synthesis Example | | | | | |
|---|---|---|---|---|---|---|
| | A-30 | A-31 | A-32 | A-33 | A-34 | A-35 |
| MMA | 68.00 | 10.31 | 2.00 | 50.00 | 47.43 | 40.30 |
| CHMA | 7.32 | — | — | — | — | — |
| n-BMA | — | 65.01 | 54.78 | 43.16 | 37.16 | 33.16 |
| BA | — | — | — | — | — | — |
| 2-EHMA | — | — | — | — | — | — |
| MAA | 0.61 | 0.61 | 0.61 | 0.61 | 0.61 | 0.61 |
| 2-HEMA | 23.17 | 23.17 | 41.71 | 5.33 | 13.90 | 25.03 |
| FA-711MM | — | — | — | — | — | — |
| FA-712HM | 0.90 | 0.90 | 0.90 | 0.90 | 0.90 | 0.90 |
| AIBN | 0.08 | 0.06 | 0.15 | 0.08 | 0.08 | 0.08 |
| Synthesis | 80 | 80 | 80 | 80 | 80 | 80 |
| temperature (° C.) | | | | | | |
| OH value | 100 | 100 | 180 | 23 | 60 | 108 |
| (mgKOH/g) | | | | | | |
| Acid value | 4 | 4 | 4 | 4 | 4 | 4 |
| (mgKOH/g) | | | | | | |
| Tg (° C.) | 90 | 35 | 35 | 60 | 60 | 60 |
| Mn | 80000 | 80000 | 50000 | 80000 | 80000 | 80000 |
| Mw | 350000 | 800000 | 120000 | 300000 | 300000 | 300000 |
| Mw/Mn | 4.3 | 9.5 | 2.3 | 3.6 | 3.8 | 3.8 |
| content percentage | 100% | 100% | 100% | 100% | 100% | 100% |
| of monomer having | | | | | | |
| one hydroxy group | | | | | | |
| ratio of primary OH | 100% | 100% | 100% | 100% | 100% | 100% |
| group | | | | | | |

TABLE 4

| | Synthesis Example | | | | | | | | | |
|---|---|---|---|---|---|---|---|---|---|---|
| | A-36 | A-37 | A-38 | A-39 | A-40 | A-41 | A-42 | A-43 | A-44 | A-45 |
| MMA | 4.35 | 60 | 25 | 55.3 | | 43.53 | | | | 30 |
| n-BMA | 82.54 | 10 | 55 | 38.39 | 96.09 | 42.76 | 80.3 | 96.7 | 25 | 21 |
| 2-EHMA | | | | | | | 15.39 | | 60 | |
| MAA | 0.61 | 0.61 | 0.61 | 0.61 | 0.61 | 0.61 | 0.61 | | 1 | 3 |
| 2-HEMA | 11.5 | 26 | 15 | 3.5 | 1.5 | 6 | 1.2 | 1.5 | 12 | 40 |
| GLMA | | 2.39 | 3.39 | 1.2 | 0.8 | 4.1 | 1 | 0.8 | 1 | 5 |
| 2,3-DHMA | | | | | | 2 | 0.5 | | | |
| FA-711MM | 1 | 1 | 1 | 1 | 1 | 1 | 1 | 1 | 1 | 1 |
| AIBN | 0.1 | 0.1 | 0.1 | 0.08 | 0.08 | 0.08 | 0.08 | 0.08 | 0.08 | 0.08 |
| Synthesis | 76 | 77 | 78 | 78 | 77 | 77 | 78 | 78 | 78 | 79 |
| temperature (° C.) | | | | | | | | | | |
| OH value | 50 | 120 | 80 | 20 | 10 | 65 | 15 | 10 | 55 | 190 |
| (mgKOH/g) | | | | | | | | | | |
| Acid value | 4 | 4 | 4 | 4 | 4 | 4 | 4 | 0 | 6 | 20 |
| (mgKOH/g) | | | | | | | | | | |
| Tg (° C.) | 27 | 78 | 45 | 63 | 20 | 55 | 16 | 20 | 5 | 60 |
| Mn | 49000 | 56000 | 63000 | 57000 | 84000 | 95000 | 96000 | 71000 | 101000 | 91000 |
| Mw | 152000 | 180000 | 258000 | 239000 | 321000 | 351000 | 298000 | 319000 | 425000 | 430000 |
| Mw/Mn | 3.1 | 3.2 | 4.1 | 4.2 | 3.8 | 3.7 | 3.1 | 4.5 | 4.2 | 4.7 |
| content | 100% | 93% | 84% | 78% | 70% | 55% | 50% | 70% | 94% | 91% |
| percentage | | | | | | | | | | |
| of monomer | | | | | | | | | | |
| having one | | | | | | | | | | |
| hydroxy group | | | | | | | | | | |
| ratio of | 100% | 94% | 87% | 82% | 77% | 60% | 56% | 77% | 94% | 92% |
| primary | | | | | | | | | | |
| OH group | | | | | | | | | | |

TABLE 5

| | Synthesis Example | | | | | | | | | | |
|---|---|---|---|---|---|---|---|---|---|---|---|
| | A′-101 | A′-102 | A′-103 | A′-104 | A′-105 | A′-106 | A′-107 | A′-108 | A′-109 | A′-110 | A′-111 |
| MMA | 10 | 11 | 40 | 6.7 | 30 | | 95.39 | 60.39 | | 93.5 | 8 |
| n-BMA | 86 | 85.5 | 30 | 63.9 | 49 | | | 37.5 | 45.39 | 1 | 78.8 |
| CHMA | | | | | | | | | | | |
| 2-EHMA | | | 20 | | | 95.39 | | | | | |
| MAA | | | | 0.6 | 5 | 0.61 | 0.61 | 0.61 | 0.61 | 0.5 | 0.61 |
| 2-HEMA | 2 | | 10 | 27.8 | 15 | 3 | 3 | 0.5 | 53 | 5 | 11.59 |
| 2-HBMA | 2 | 1.5 | | | | | | | | | |
| GLMA | | 2 | | | | | | | | | |
| FA-711MM | | | | 1 | 1 | 1 | 1 | 1 | 1 | | 1 |
| AIBN | 0.04 | 0.1 | 0.08 | 2.5 | 0.1 | 0.08 | 0.08 | 0.08 | 0.08 | 0.3 | 3.5 |
| Synthesis | 77 | 77 | 80 | 100 | 78 | 78 | 78 | 75 | 85 | 80 | 77 |
| temperature (° C.) | | | | | | | | | | | |
| OH value | 16 | 19 | 33.5 | 120 | 65 | 13 | 13 | 2 | 230 | 20 | 50 |
| (mgKOH/g) | | | | | | | | | | | |
| Acid value | 0 | 0 | 0 | 4 | 30 | 4 | 4 | 4 | 4 | 3.25 | 4 |
| (mgKOH/g) | | | | | | | | | | | |
| Tg (° C.) | 28 | 28 | 24 | 34 | 50 | −10 | 100 | 66 | 34 | 101 | 30 |
| Mn | 145000 | 52000 | 75000 | 18000 | 67000 | 90000 | 81000 | 88000 | 52000 | 29000 | 26000 |
| Mw | 450000 | 150000 | 165000 | 210000 | 301000 | 452000 | 397000 | 203000 | 512000 | 130000 | 50000 |
| Mw/Mn | 3.1 | 2.9 | 2.2 | 12 | 4.5 | 5 | 4.9 | 2.3 | 9.8 | 4.5 | 1.9 |
| content | 100% | 43% | 100% | 100% | 100% | 100% | 100% | 100% | 100% | 100% | 100% |
| percentage | | | | | | | | | | | |
| of monomer | | | | | | | | | | | |
| having one | | | | | | | | | | | |
| hydroxy group | | | | | | | | | | | |
| ratio of | 55% | 36% | 100% | 100% | 100% | 100% | 100% | 100% | 100% | 100% | 100% |
| primary | | | | | | | | | | | |
| OH group | | | | | | | | | | | |

TABLE 6

| | | Isocyanate curing | | | | | | | |
|---|---|---|---|---|---|---|---|---|---|
| | Acrylic | agent (B) | | | Polyol*3 | Total light | Diffuse | Tensile | Rate of |
| Coating | copolymer | | amount | | (parts by | transmittance | transmittance | strength | elongation |
| material | (A) | Type | blended | NCO/OH | mass) | (%) | (%) | (N/mm²) | (%) |
| HC-1 | A-1 | 1 | 59.9 | 2.7 | | 90 | 1 | 31 | 195 |
| HC-2 | A-2 | 1 | 95.8 | 2.7 | | 90 | 1 | 35 | 175 |
| HC-3 | A-3 | 1 | 131.8 | 2.7 | | 90 | 1 | 40 | 150 |
| HC-4 | A-4 | 1 | 59.9 | 2.7 | | 90 | 1 | 35 | 115 |
| HC-5 | A-5 | 1 | 95.8 | 2.7 | | 90 | 1 | 40 | 95 |
| HC-6 | A-6 | 1 | 131.8 | 2.7 | | 90 | 1 | 46 | 70 |
| HC-7 | A-7 | 1 | 59.9 | 2.7 | | 90 | 1 | 50 | 80 |
| HC-8 | A-8 | 1 | 131.8 | 3.7 | | 90 | 1 | 60 | 70 |
| HC-9 | A-9 | 1 | 131.8 | 2.7 | | 90 | 1 | 75 | 55 |
| HC-10 | A-10 | 2 | 19.8 | 2.5 | | 90 | 1 | 32 | 80 |
| HC-11 | A-11 | 2 | 12.9 | 2.5 | | 90 | 1 | 35 | 69 |
| HC-12 | A-12 | 1 | 155.7 | 2.7 | | 90 | 1 | 32 | 170 |
| HC-13 | A-13 | 1 | 191.7 | 2.7 | | 90 | 1 | 36 | 190 |
| HC-14 | A-14 | 2 | 5.0 | 2.5 | | 90 | 1 | 19 | 150 |
| HC-15 | A-15 | 2 | 14.9 | 2.5 | | 90 | 1 | 20 | 160 |
| HC-16 | A-16 | 2 | 24.8 | 2.5 | | 90 | 1 | 25 | 140 |
| HC-17 | A-17 | 1 | 41.9 | 2.7 | | 90 | 1 | 25 | 130 |
| HC-18 | A-18 | 1 | 53.9 | 2.7 | | 90 | 1 | 30 | 150 |
| HC-19 | A-19 | 1 | 18.0 | 2.7 | | 90 | 1 | 15 | 180 |
| HC-20 | A-20 | 1 | 18.0 | 2.7 | | 90 | 1 | 20 | 200 |
| HC-21 | A-21 | 1 | 30.0 | 2.7 | | 90 | 1 | 25 | 160 |
| HC-22 | A-22 | 1 | 41.9 | 2.7 | | 90 | 1 | 28 | 160 |

TABLE 7

| | | Isocyanate curing | | | | | | | |
|---|---|---|---|---|---|---|---|---|---|
| | | agent | | | Polyol*3 | Total light | Diffuse | Tensile | Rate of |
| Coating | Acrylic | | amount | | (parts by | transmittance | transmittance | strength | elongation |
| material | copolymer | Type*1 | blended*2 | NCO/OH | mass) | (%) | (%) | (N/mm2) | (%) |
| HC-23 | A-23 | 1 | 12.0 | 2.7 | | 90 | 1 | 22 | 142 |
| HC-24 | A-24 | 1 | 59.9 | 2.7 | | 90 | 1 | 35 | 115 |
| HC-25 | A-25 | 1 | 119.8 | 2.7 | | 90 | 1 | 46 | 70 |
| HC-26 | A-26 | 1 | 179.7 | 2.7 | | 90 | 1 | 80 | 45 |
| HC-27 | A-27 | 1 | 119.8 | 2.7 | | 90 | 1 | 32 | 100 |
| HC-28 | A-28 | 1 | 119.8 | 2.7 | | 90 | 1 | 42 | 73 |
| HC-29 | A-29 | 1 | 119.8 | 2.7 | | 90 | 1 | 51 | 55 |
| HC-30 | A-30 | 1 | 119.8 | 2.7 | | 90 | 1 | 72 | 45 |
| HC-31 | A-31 | 1 | 119.8 | 2.7 | | 90 | 1 | 53 | 80 |
| HC-32 | A-32 | 1 | 215.6 | 2.7 | | 90 | 1 | 91 | 42 |
| HC-33 | A-33 | 1 | 27.6 | 2.7 | | 90 | 1 | 38 | 135 |
| HC-34 | A-34 | 1 | 71.9 | 2.7 | | 90 | 1 | 43 | 130 |
| HC-35 | A-35 | 1 | 129.4 | 2.7 | | 90 | 1 | 48 | 65 |
| HC-36 | A-36 | 2 | 49.7 | 2.5 | | 90 | 1 | 50 | 120 |
| HC-37 | A-37 | 2 | 119.2 | 2.5 | | 90 | 1 | 75 | 80 |
| HC-38 | A-38 | 2 | 79.5 | 2.5 | | 90 | 1 | 60 | 100 |
| HC-39 | A-39 | 2 | 19.9 | 2.5 | | 90 | 1 | 35 | 130 |
| HC-40 | A-40 | 2 | 9.9 | 2.5 | | 90 | 1 | 32 | 190 |
| HC-41 | A-41 | 2 | 59.9 | 2.5 | | 90 | 1 | 30 | 195 |
| HC-42 | A-42 | 2 | 14.9 | 2.5 | | 90 | 1 | 29 | 200 |
| HC-43 | A-43 | 2 | 9.9 | 2.5 | | 90 | 1 | 30 | 200 |
| HC-44 | A-44 | 2 | 54.6 | 2.5 | | 90 | 1 | 50 | 100 |
| HC-45 | A-45 | 2 | 188.7 | 2.5 | | 90 | 1 | 90 | 15 |
| HC-46 | A-7 | 1 | 11.25 | 0.5 | | 90 | 1 | 30 | 130 |
| HC-47 | A-7 | 1 | 22.5 | 1.0 | | 90 | 1 | 40 | 100 |
| HC-48 | A-7 | 1 | 45 | 2.0 | | 90 | 1 | 45 | 90 |
| HC-49 | A-7 | 1 | 67.5 | 3.0 | | 90 | 1 | 50 | 80 |
| HC-50 | A-7 | 1 | 90 | 4.0 | | 90 | 1 | 55 | 70 |
| HC-51 | A-11 | 2 | 12.9 | 2.5 | 5.0 | 90 | 1 | 32 | 100 |
| HC-52 | A-12 | 1 | 155.7 | 2.7 | 25.0 | 90 | 1 | 29 | 200 |
| HC-53 | A-16 | 2 | 24.8 | 2.5 | 10.0 | 90 | 1 | 20 | 160 |
| HC-54 | A-17 | 1 | 41.9 | 2.7 | 15.0 | 90 | 1 | 24 | 170 |

TABLE 8

| | | | | | | | Sunscreen | |
|---|---|---|---|---|---|---|---|---|
| | Coating | | Solvent | Pencil | Abrasion | | cream | Weather |
| Example | material | Adhesion | resistance | hardness | resistance | Moldability | resistance | resistance |
| 101 | HC-1 | 100 | 4 | HB | 3 | 4 | 3 | 4 |
| 102 | HC-2 | 98 | 4 | HB | 3 | 3 | 3 | 4 |
| 103 | HC-3 | 95 | 4 | HB | 3 | 3 | 3 | 4 |
| 104 | HC-4 | 100 | 4 | F | 3 | 4 | 3 | 4 |
| 105 | HC-5 | 98 | 4 | F | 3 | 3 | 3 | 4 |
| 106 | HC-6 | 95 | 4 | F | 3 | 3 | 4 | 4 |
| 107 | HC-7 | 100 | 4 | H | 4 | 4 | 4 | 4 |
| 108 | HC-8 | 98 | 4 | H | 4 | 3 | 4 | 4 |
| 109 | HC-9 | 95 | 4 | H | 4 | 3 | 4 | 4 |
| 110 | HC-10 | 100 | 4 | H | 4 | 3 | 3 | 4 |
| 111 | HC-11 | 100 | 4 | H | 4 | 3 | 3 | 4 |
| 112 | HC-12 | 93 | 4 | HB | 3 | 3 | 4 | 4 |
| 113 | HC-13 | 90 | 4 | HB | 3 | 2 | 4 | 4 |
| 114 | HC-14 | 100 | 3 | HB | 3 | 4 | 2 | 4 |
| 115 | HC-15 | 100 | 3 | F | 4 | 4 | 3 | 4 |
| 116 | HC-16 | 100 | 4 | F | 4 | 4 | 3 | 4 |
| 117 | HC-17 | 100 | 4 | H | 4 | 4 | 3 | 4 |
| 118 | HC-18 | 100 | 4 | H | 4 | 4 | 3 | 4 |
| 119 | HC-19 | 100 | 4 | F | 4 | 4 | 3 | 4 |
| 120 | HC-20 | 100 | 4 | F | 4 | 4 | 3 | 4 |
| 121 | HC-21 | 100 | 4 | F | 4 | 4 | 3 | 4 |
| 122 | HC-22 | 100 | 4 | H | 4 | 4 | 3 | 4 |

TABLE 9

| | | | | | | | Sunscreen | |
|---|---|---|---|---|---|---|---|---|
| | Coating | | Solvent | Pencil | Abrasion | | cream | Weather |
| Example | material | Adhesion | resistance | hardness | resistance | Moldability | resistance | resistance |
| 123 | HC-23 | 100 | 3 | HB | 4 | 4 | 2 | 4 |
| 124 | HC-24 | 100 | 4 | F | 4 | 4 | 3 | 4 |
| 125 | HC-25 | 95 | 4 | F | 4 | 3 | 4 | 4 |
| 126 | HC-26 | 92 | 4 | H | 4 | 3 | 4 | 4 |
| 127 | HC-27 | 95 | 4 | H | 4 | 3 | 4 | 4 |
| 128 | HC-28 | 95 | 4 | H | 4 | 3 | 4 | 4 |
| 129 | HC-29 | 95 | 4 | H | 4 | 3 | 4 | 4 |
| 130 | HC-30 | 95 | 4 | H | 4 | 3 | 4 | 4 |
| 131 | HC-31 | 95 | 4 | H | 4 | 3 | 4 | 4 |
| 132 | HC-32 | 90 | 4 | 2H | 4 | 2 | 4 | 4 |
| 133 | HC-33 | 100 | 3 | F | 4 | 4 | 3 | 4 |
| 134 | HC-34 | 99 | 4 | F | 4 | 3 | 4 | 4 |
| 135 | HC-35 | 95 | 4 | H | 4 | 3 | 4 | 4 |
| 136 | HC-36 | 100 | 4 | H | 4 | 4 | 3 | 4 |
| 137 | HC-37 | 93 | 4 | H | 4 | 3 | 4 | 4 |
| 138 | HC-38 | 98 | 4 | F | 4 | 3 | 3 | 4 |
| 139 | HC-39 | 100 | 4 | F | 4 | 4 | 3 | 4 |
| 140 | HC-40 | 100 | 3 | HB | 3 | 4 | 2 | 4 |
| 141 | HC-41 | 99 | 3 | HB | 3 | 3 | 2 | 4 |
| 142 | HC-42 | 100 | 3 | HB | 3 | 4 | 2 | 4 |
| 143 | HC-43 | 100 | 3 | HB | 3 | 4 | 2 | 4 |
| 144 | HC-44 | 99 | 4 | H | 4 | 3 | 3 | 4 |
| 145 | HC-45 | 85 | 4 | 2H | 4 | 3 | 4 | 4 |
| 146 | HC-46 | 100 | 3 | HB | 3 | 4 | 3 | 4 |
| 147 | HC-47 | 100 | 4 | H | 4 | 4 | 3 | 4 |
| 148 | HC-48 | 100 | 4 | H | 4 | 4 | 3 | 4 |
| 149 | HC-49 | 100 | 4 | H | 4 | 4 | 3 | 4 |
| 150 | HC-50 | 100 | 4 | H | 4 | 3 | 3 | 4 |
| 151 | HC-51 | 93 | 4 | H | 4 | 3 | 3 | 4 |
| 152 | HC-52 | 90 | 4 | HB | 3 | 3 | 3 | 4 |
| 153 | HC-53 | 100 | 4 | F | 4 | 4 | 3 | 4 |
| 154 | HC-54 | 100 | 4 | H | 4 | 4 | 3 | 4 |

TABLE 10

| | | | | | | | Sunscreen | |
|---|---|---|---|---|---|---|---|---|
| | Coating | | Solvent | Pencil | Abrasion | | cream | Weather |
| Example | material | Adhesion | resistance | hardness | resistance | Moldability | resistance | resistance |
| 201 | HC-1 | 100 | 4 | H | 3 | 4 | 3 | 4 |
| 202 | HC-2 | 100 | 4 | H | 3 | 4 | 3 | 4 |
| 203 | HC-3 | 100 | 4 | H | 3 | 4 | 3 | 4 |
| 204 | HC-4 | 100 | 4 | 2H | 3 | 4 | 3 | 4 |
| 205 | HC-5 | 100 | 4 | 2H | 3 | 4 | 3 | 4 |
| 206 | HC-6 | 100 | 4 | 3H | 3 | 4 | 4 | 4 |
| 207 | HC-7 | 100 | 4 | 2H | 4 | 4 | 4 | 4 |
| 208 | HC-8 | 100 | 4 | 2H | 4 | 4 | 4 | 4 |
| 209 | HC-9 | 100 | 4 | 3H | 4 | 4 | 4 | 4 |
| 210 | HC-10 | 100 | 4 | 2H | 4 | 3 | 3 | 4 |
| 211 | HC-11 | 100 | 4 | H | 4 | 3 | 3 | 4 |
| 212 | HC-12 | 99 | 4 | 2H | 3 | 3 | 4 | 4 |
| 213 | HC-13 | 98 | 4 | 2H | 3 | 3 | 4 | 4 |
| 214 | HC-14 | 100 | 3 | F | 3 | 4 | 3 | 4 |
| 215 | HC-15 | 100 | 3 | H | 4 | 4 | 3 | 4 |
| 216 | HC-16 | 100 | 4 | H | 4 | 4 | 3 | 4 |
| 217 | HC-17 | 100 | 4 | 2H | 4 | 4 | 3 | 4 |
| 218 | HC-18 | 100 | 4 | 2H | 4 | 4 | 4 | 4 |
| 219 | HC-19 | 100 | 4 | H | 4 | 4 | 3 | 4 |
| 220 | HC-20 | 100 | 4 | H | 4 | 4 | 3 | 4 |
| 221 | HC-21 | 100 | 4 | 2H | 4 | 4 | 3 | 4 |
| 222 | HC-22 | 100 | 4 | 2H | 4 | 4 | 3 | 4 |

TABLE 11

| | | | | | | | Sunscreen | |
|---|---|---|---|---|---|---|---|---|
| | Coating | | Solvent | Pencil | Abrasion | | cream | Weather |
| Example | material | Adhesion | resistance | hardness | resistance | Moldability | resistance | resistance |
| 223 | HC-23 | 100 | 3 | H | 4 | 4 | 2 | 4 |
| 224 | HC-24 | 100 | 4 | 2H | 4 | 4 | 3 | 4 |
| 225 | HC-25 | 100 | 4 | 3H | 4 | 4 | 4 | 4 |
| 226 | HC-26 | 98 | 4 | 4H | 4 | 3 | 4 | 4 |
| 227 | HC-27 | 100 | 4 | 3H | 4 | 4 | 4 | 4 |
| 228 | HC-28 | 100 | 4 | 3H | 4 | 4 | 4 | 4 |
| 229 | HC-29 | 100 | 4 | 3H | 4 | 4 | 4 | 4 |
| 230 | HC-30 | 100 | 4 | 3H | 4 | 3 | 4 | 4 |
| 231 | HC-31 | 100 | 4 | 3H | 4 | 4 | 4 | 4 |
| 232 | HC-32 | 90 | 4 | 4H | 4 | 3 | 4 | 4 |
| 233 | HC-33 | 100 | 3 | 2H | 4 | 4 | 3 | 4 |
| 234 | HC-34 | 100 | 4 | 2H | 4 | 4 | 4 | 4 |
| 235 | HC-35 | 100 | 4 | 3H | 4 | 4 | 4 | 4 |
| 236 | HC-36 | 100 | 4 | 2H | 4 | 4 | 3 | 4 |
| 237 | HC-37 | 100 | 4 | 2H | 4 | 4 | 4 | 4 |
| 238 | HC-38 | 100 | 4 | H | 4 | 4 | 3 | 4 |
| 239 | HC-39 | 100 | 4 | H | 4 | 4 | 3 | 4 |
| 240 | HC-40 | 100 | 3 | F | 3 | 4 | 3 | 4 |
| 241 | HC-41 | 100 | 3 | F | 3 | 4 | 3 | 4 |
| 242 | HC-42 | 100 | 3 | F | 3 | 4 | 3 | 4 |
| 243 | HC-43 | 100 | 3 | F | 3 | 4 | 3 | 4 |
| 244 | HC-44 | 100 | 4 | 2H | 4 | 4 | 3 | 4 |
| 245 | HC-45 | 90 | 4 | 3H | 4 | 3 | 4 | 4 |
| 246 | HC-46 | 100 | 3 | F | 3 | 4 | 3 | 4 |
| 247 | HC-47 | 100 | 4 | 2H | 4 | 4 | 3 | 4 |
| 248 | HC-48 | 100 | 4 | 2H | 4 | 4 | 3 | 4 |
| 249 | HC-49 | 100 | 4 | 2H | 4 | 4 | 3 | 4 |
| 250 | HC-50 | 100 | 4 | 2H | 4 | 3 | 3 | 4 |
| 251 | HC-51 | 100 | 4 | 2H | 4 | 4 | 3 | 4 |
| 252 | HC-52 | 99 | 4 | F | 3 | 4 | 3 | 4 |
| 253 | HC-53 | 100 | 4 | H | 4 | 4 | 3 | 4 |
| 254 | HC-54 | 100 | 4 | 2H | 4 | 4 | 3 | 4 |

TABLE 12

| | | | | | | | Sunscreen | |
|---|---|---|---|---|---|---|---|---|
| | Coating | | Solvent | Pencil | Abrasion | | cream | Weather |
| Example | material | Adhesion | resistance | hardness | resistance | Moldability | resistance | resistance |
| 301 | HC-1 | 100 | 4 | HB | 3 | 4 | 3 | 4 |
| 302 | HC-2 | 100 | 4 | HB | 3 | 4 | 4 | 4 |
| 303 | HC-3 | 100 | 4 | HB | 3 | 4 | 4 | 4 |
| 304 | HC-4 | 100 | 4 | F | 3 | 4 | 4 | 4 |
| 305 | HC-5 | 100 | 4 | F | 3 | 4 | 4 | 4 |
| 306 | HC-6 | 100 | 4 | F | 3 | 4 | 4 | 4 |
| 307 | HC-7 | 100 | 4 | H | 4 | 4 | 4 | 4 |
| 308 | HC-8 | 100 | 4 | H | 4 | 4 | 4 | 4 |
| 309 | HC-9 | 100 | 4 | H | 4 | 4 | 4 | 4 |
| 310 | HC-10 | 100 | 4 | H | 4 | 3 | 3 | 4 |
| 311 | HC-11 | 100 | 4 | H | 4 | 3 | 3 | 4 |
| 312 | HC-12 | 100 | 4 | HB | 3 | 4 | 4 | 4 |
| 313 | HC-13 | 100 | 4 | HB | 3 | 4 | 4 | 4 |
| 314 | HC-14 | 100 | 3 | HB | 3 | 4 | 3 | 4 |
| 315 | HC-15 | 100 | 3 | F | 4 | 4 | 4 | 4 |
| 316 | HC-16 | 100 | 4 | F | 4 | 4 | 4 | 4 |
| 317 | HC-17 | 100 | 4 | H | 4 | 4 | 4 | 4 |
| 318 | HC-18 | 100 | 4 | H | 4 | 4 | 4 | 4 |
| 319 | HC-19 | 100 | 4 | F | 4 | 4 | 4 | 4 |
| 320 | HC-20 | 100 | 4 | F | 4 | 4 | 4 | 4 |
| 321 | HC-21 | 100 | 4 | F | 4 | 4 | 4 | 4 |
| 322 | HC-22 | 100 | 4 | H | 4 | 4 | 4 | 4 |

TABLE 13

| | | | | | | | Sunscreen | |
|---|---|---|---|---|---|---|---|---|
| | Coating | | Solvent | Pencil | Abrasion | | cream | Weather |
| Example | material | Adhesion | resistance | hardness | resistance | Moldability | resistance | resistance |
| 323 | HC-23 | 100 | 3 | F | 4 | 4 | 3 | 4 |
| 324 | HC-24 | 100 | 4 | H | 4 | 4 | 4 | 4 |
| 325 | HC-25 | 100 | 4 | 2H | 4 | 4 | 4 | 4 |
| 326 | HC-26 | 100 | 4 | 3H | 4 | 4 | 4 | 4 |
| 327 | HC-27 | 100 | 4 | 2H | 4 | 4 | 4 | 4 |
| 328 | HC-28 | 100 | 4 | 2H | 4 | 4 | 4 | 4 |
| 329 | HC-29 | 100 | 4 | 2H | 4 | 4 | 4 | 4 |
| 330 | HC-30 | 100 | 4 | 2H | 4 | 3 | 4 | 4 |
| 331 | HC-31 | 100 | 4 | 2H | 4 | 4 | 4 | 4 |
| 332 | HC-32 | 100 | 4 | 3H | 4 | 4 | 4 | 4 |
| 333 | HC-33 | 100 | 3 | H | 4 | 4 | 4 | 4 |
| 334 | HC-34 | 100 | 4 | H | 4 | 4 | 4 | 4 |
| 335 | HC-35 | 100 | 4 | 2H | 4 | 4 | 4 | 4 |
| 336 | HC-36 | 100 | 4 | H | 4 | 4 | 4 | 4 |
| 337 | HC-37 | 100 | 4 | H | 4 | 4 | 4 | 4 |
| 338 | HC-38 | 100 | 4 | F | 4 | 4 | 4 | 4 |
| 339 | HC-39 | 100 | 4 | F | 4 | 4 | 3 | 4 |
| 340 | HC-40 | 100 | 3 | HB | 3 | 4 | 3 | 4 |
| 341 | HC-41 | 100 | 3 | HB | 3 | 4 | 4 | 4 |
| 342 | HC-42 | 100 | 3 | HB | 3 | 4 | 3 | 4 |
| 343 | HC-43 | 100 | 3 | HB | 3 | 4 | 3 | 4 |
| 344 | HC-44 | 100 | 4 | H | 4 | 4 | 4 | 4 |
| 345 | HC-45 | 100 | 4 | 2H | 4 | 3 | 4 | 4 |
| 346 | HC-46 | 100 | 3 | HB | 3 | 4 | 4 | 4 |
| 347 | HC-47 | 100 | 4 | H | 4 | 4 | 4 | 4 |
| 348 | HC-48 | 100 | 4 | H | 4 | 4 | 4 | 4 |
| 349 | HC-49 | 100 | 4 | H | 4 | 4 | 4 | 4 |
| 350 | HC-50 | 100 | 4 | H | 4 | 4 | 4 | 4 |
| 351 | HC-51 | 100 | 4 | H | 4 | 4 | 4 | 4 |
| 352 | HC-52 | 100 | 4 | HB | 3 | 3 | 4 | 4 |
| 353 | HC-53 | 100 | 4 | F | 4 | 4 | 4 | 4 |
| 354 | HC-54 | 100 | 4 | H | 4 | 4 | 4 | 4 |

TABLE 14

| | | Isocyanate curing | | | | | | |
|---|---|---|---|---|---|---|---|---|
| | | agent | | | Total light | Diffuse | Tensile | Rate of |
| Comparative | Acrylic | | amount | | transmittance | transmittance | strength | elongation |
| Example | copolymer | Type* | blended ** | NCO/OH | (%) | (%) | (N/mm2) | (%) |
| 1 | A′-101 | 1 | 59.9 | 2.7 | 90 | 1 | 24 | 110 |
| 2 | A′-102 | 1 | 32.9 | 2.7 | 90 | 1 | 20 | 150 |
| 3 | A′-103 | 1 | 95.8 | 2.7 | 90 | 1 | 20 | 10 |
| 4 | A′-104 | 1 | 131.8 | 2.7 | 90 | 1 | 20 | 210 |
| 5 | A′-105 | 1 | 59.9 | 2.7 | 90 | 1 | 50 | 20 |
| 6 | A′-106 | 1 | 95.8 | 2.7 | 90 | 1 | 5 | 300 |
| 7 | A′-107 | 1 | 131.8 | 2.7 | 90 | 1 | 120 | 20 |
| 8 | A′-108 | 1 | 59.9 | 2.7 | 90 | 1 | 5 | 300 |
| 9 | A′-109 | 1 | 131.8 | 3.7 | 90 | 1 | 110 | 5 |
| 10 | A-1 | | | 0.0 | 91 | 0.7 | 1 | 300 |
| 11 | A′-110 | 3 | 16.7 | 1.0 | 89 | 1.5 | 10 | 200 |
| 12 | A′-110 | 3 | 16.7 | 1.0 | 88 | 1.6 | 13 | 180 |
| 13 | A′-111 | 1 | 59.9 | 2.66 | 90 | 1 | 5 | 50 |

| | | | | | | Sunscreen | |
|---|---|---|---|---|---|---|---|
| Comparative | | Solvent | Pencil | Abrasion | | cream | Weather |
| Example | Adhesion | resistance | hardness | resistance | Moldability | resistance | resistance |
| 1 | 100 | 2 | B | 1 | 4 | 2 | 4 |
| 2 | 100 | 1 | HB | 3 | 4 | 1 | 4 |
| 3 | 100 | 2 | HB | 2 | 2 | 2 | 4 |
| 4 | 90 | 1 | B | 1 | 4 | 1 | 4 |
| 5 | 99 | 4 | F | 4 | 2 | 4 | 4 |
| 6 | 100 | 1 | 3B | 1 | 4 | 1 | 4 |
| 7 | 100 | 4 | H | 4 | 1 | 4 | 4 |
| 8 | 100 | 1 | B | 1 | 4 | 1 | 4 |
| 9 | 80 | 4 | 2H | 4 | 1 | 4 | 4 |
| 10 | 100 | 1 | 2B | 1 | 4 | 1 | 4 |
| 11 | 100 | 1 | B | 1 | 4 | 1 | 1 |
| 12 | 100 | 1 | HB | 1 | 3 | 1 | 2 |
| 13 | 100 | 1 | B | 2 | 4 | 1 | 4 |

As shown in Tables 7 to 13, in Examples 101 to 154, 201 to 254, and 301 to 354, the hard coat layer which is a cured product of an appropriate acrylic copolymer and isocyanate curing agent exhibits a proper tensile strength, and the decorated molded article obtained using the decorative film having the hard coat layer is excellent in adhesion, solvent resistance, pencil hardness, abrasion resistance, moldability, sunscreen cream resistance, and weather resistance.

On the other hand, as shown in Table 14, in Comparative Example 1, the amount of unreacted components is large due to a small ratio of the primary hydroxy group to the hydroxy groups in the acrylic copolymer, resulting in poor solvent resistance, pencil hardness, abrasion resistance, and sunscreen cream resistance.

In Comparative Example 2, a cured film with inhomogeneous cross-links is formed because the ratio of the monomer having one hydroxy group in the molecule in 100% by mol of the hydroxy group-containing monomers subjected to the formation of the acrylic copolymer is less than 50% by mol, resulting in poor durability such as solvent resistance, pencil hardness, abrasion resistance, and sunscreen cream resistance.

In Comparative Example 3, a large amount of high-molecular-weight components and severe constraints between molecular chains appear because the polydispersity index of the acrylic copolymer is less than 2.3, resulting in a low rate of elongation and poor moldability.

In Comparative Example 4, the amount of low-molecular-weight components is large because the polydispersity index of the acrylic copolymer is larger than 10, resulting in poor sunscreen cream resistance.

In Comparative Example 5, a hard cured film is formed by accelerating the curing of the hydroxy groups and the isocyanate groups because the acid value of the acrylic copolymer is larger than 20 mgKOH/g, resulting in a low rate of elongation and poor moldability.

In Comparative Example 6, the glass transition temperature of the acrylic copolymer is lower than 0° C., and the tensile strength of the cured film is smaller than 15 N/mm², resulting in poor pencil hardness, abrasion resistance, and sunscreen cream resistance.

In Comparative Example 7, the glass transition temperature of the acrylic copolymer is higher than 80° C., and the tensile strength is larger than 100 N/mm², resulting in poor moldability.

In Comparative Example 8, the hydroxy value of the acrylic copolymer is lower than 5 mgKOH/g, and the tensile strength is smaller than 15 N/mm², resulting in poor pencil hardness, abrasion resistance, and sunscreen cream resistance.

In Comparative Example 9, the tensile strength is too large because the hydroxy value of the acrylic copolymer is larger than 210 mgKOH/g, resulting in poor moldability.

In Comparative Example 10, the absence of the isocyanate curing agent results in good spreading and excellent moldability, but poor pencil hardness, abrasion resistance, and sunscreen cream resistance.

In Comparative Examples 11 and 12, which include a photocurable component as a third component, the tensile strength is smaller than 15 N/mm² regardless of the presence or absence of photocuring, resulting in poor pencil hardness, abrasion resistance, and sunscreen cream resistance.

In Comparative Example 13, the tensile strength is smaller than 15 N/mm² because the acrylic copolymer has a small weight-average molecular weight, resulting in poor solvent resistance, pencil hardness, abrasion resistance, and sunscreen cream resistance.

### Example 401

A hard coat layer was formed on a polycarbonate base material in the same way as in Example 101 to obtain member 1.

To 100 parts by mass (solid mass) of the acrylic copolymer (A-1), 60 parts by mass (solid mass) of a polyisocyanate compound P301-75E (manufactured by Asahi Kasei Chemicals Corp., polyisocyanate compound), 5 parts by mass (solid mass) of MA100 (manufactured by Mitsubishi Chemical Corp., carbon black), and 0.5 parts by mass (solid mass) of BYK-9076 (manufactured by BYK Additives & Instruments, dispersant) were added, further propylene glycol 1-monomethyl ether 2-acetate (PGMAc) was added so as to attain 30% solids, and the mixture was stirred to obtain a colored curable resin composition.

The colored curable resin composition was applied onto the polycarbonate film side of the member 1 using a bar coater and dried in an oven of 100° C. for 1 minute for solvent volatilization to establish a colored layer having a thickness of 5 μm.

Subsequently, an adhesive (manufactured by Toyo Morton, Ltd., AD-76G1) was applied onto the colored layer such that the film thickness after drying was 5 μm to obtain a decorative film with the adhesive layer and the colored layer.

A decorated molded article carrying the decorative film on the surface on the convex side of a square steel sheet member (decoratable object) having the shape given below was obtained according to the following procedures.

<Procedures>

The square steel sheet member was mounted in a molding machine, while the decorative film was placed above the steel sheet member such that the adhesive layer faced the steel sheet member in no contact.

Next, the decorative film was heated to approximately 160° C., while the surface of the steel sheet member was vacuum-molded under a vacuum suction power of approximately 1.5 atm, and the adhesive layer and the colored layer were cured to obtain a decorated molded article carrying the decorative film on the steel sheet member surface.

<Square Steel Sheet Member>

A steel sheet was molded into a square shape of 90 mm in length×90 mm in width×5 mm in depth with corner R of approximately 10.

### <<Adhesion>>

The convex surface (surface of 90 mm in length×90 mm in width) of the decorated molded article was deeply scratched in a grid pattern from the hard coat layer side so as to arrive at the interface between the decorative film and the decoratable object, followed by an adhesion test by the tape-peeling method in accordance with JIS K-5400. The number of unstripped grids in 100 grids was counted, and the adhesion of the decorative film to the decoratable object was evaluated on the basis of the following criteria.

Circle (good): The stripped area was 0%.
Triangle (fair): The stripped area was larger than 0% and less than 35%.
X-mark (poor): The stripped area was 35% or more.

### Examples 402 to 422

Each decorative film with an adhesive layer and a colored layer was obtained in the same way as in Example 401 except that the adhesive shown in Table 15 was used instead of the adhesive used in Example 401.

Subsequently, molding and adhesion were evaluated in the same way as in Example 401 using the decoratable object described in Table 15.

The decoratable object ABS represents an acrylonitrile-butadiene-styrene resin, and CFRP represents a carbon fiber-reinforced resin. Their respective shapes were the same as in the steel sheet member of Example 401.

### Example 423

A decorative film with a colored layer was obtained in the same way as in Example 401 except that no adhesive layer was established.

The obtained decorative film was inserted into the cavity of a die for injection molding, vacuum-aspirated under a condition of approximately 1.5 atm with heating to approximately 160° C., and premolded into a square shape (square shape of 90 mm in length×90 mm in width×5 mm in depth, corner R: approximately 10).

Subsequently, an ABS resin was injection-molded at a thickness of approximately 3 mm onto the colored layer side of the premolded article at a molding temperature of 220 to 240° C. and a die temperature of 30 to 50° C. to obtain a decorated molded article.

The obtained decorated molded article was evaluated for the adhesion of the decorative film to the decoratable object in the same way as in Example 401.

### Example 424

A decorated molded article was prepared in the same way as in Example 423 except that the injection resin was changed from the ABS resin to a carbon fiber-reinforced resin (CFRP). The decorated molded article was evaluated in the same way as therein.

TABLE 15

| | Coating | | | |
|---|---|---|---|---|
| | material | | | |
| | for hard | | Decoratable | Adhe- |
| Example | coat | Adhesive | object | sion |
| 401 | HC-1 | AD-76G1 | Steel sheet | good |
| 402 | | ORIBAIN BPS1109 | | good |
| 403 | | ORIBAIN BPS5209 | | good |
| 404 | | ORIBAIN BPS5296 | | good |
| 405 | | ORIBAIN BPS5513 | ABS | good |
| 406 | | ORIBAIN BPS6153K | | good |
| 407 | | ARONTAC S-1511X | | good |
| 408 | | ARONTAC HV-C 9500 | | good |
| 409 | | ORIBAIN BPS6076HTF | CFRP | good |
| 410 | | ORIBAIN SP-205 | | good |
| 411 | | SD 4580 PSA | | good |
| 412 | | EVAFLEX EV45LX | Steel sheet | good |
| 413 | | EVAFLEX EV260 | | good |
| 414 | | EVAFLEX P 1007 | | good |
| 415 | | ULTRASEN 631 | | good |
| 416 | | HI-MILAN 1650 | ABS | good |
| 417 | | Scotch-Weld 3748 | | good |
| 418 | | Scotch-Weld 3779 | | good |
| 419 | | MACROMELT 6239 | | good |
| 420 | | ALONMELT PES-111EE | CFRP | good |
| 421 | | Hi-Bon 4832FA | | good |
| 422 | | HAMATITE M-6209 | | good |
| 423 | | — | ABS | good |
| 424 | | — | CFRP | good |

AD-76G1: manufactured by Toyo-Morton, Ltd., laminate adhesive
ORIBAIN BPS1109: manufactured by Toyochem Co., Ltd., acrylic pressure-sensitive adhesive
ORIBAIN BPS5209: manufactured by Toyochem Co., Ltd., acrylic pressure-sensitive adhesive
ORIBAIN BPS5296: manufactured by Toyochem Co., Ltd., acrylic pressure-sensitive adhesive
ORIBAIN BPS5513: manufactured by Toyochem Co., Ltd., acrylic pressure-sensitive adhesive
ORIBAIN BPS6153K: manufactured by Toyochem Co., Ltd., acrylic pressure-sensitive adhesive
ORIBAIN BPS6074HTF: manufactured by Toyochem Co., Ltd., acrylic pressure-sensitive adhesive
ARONTAC S-1511X: manufactured by Toagosei Co., Ltd., acrylic pressure-sensitive adhesive
ARONTAC HV-C 9500: manufactured by Toagosei Co., Ltd., acrylic emulsion pressure-sensitive adhesive
ORIBAIN SP-205: manufactured by Toyochem Co., Ltd., urethane pressure-sensitive adhesive
ORIBAIN BPS5079-1: manufactured by Toyochem Co., Ltd., rubber pressure-sensitive adhesive
SD 4580 PSA: manufactured by Dow Corning Toray Co., Ltd., silicone pressure-sensitive adhesive
EVAFLEX EV45LX: manufactured by Du Pont-Mitsui Polychemicals Co., Ltd., ethylene-vinyl acetate copolymer hot-melt adhesive
EVAFLEX EV260: manufactured by Du Pont-Mitsui Polychemicals Co., Ltd., ethylene-vinyl acetate copolymer hot-melt adhesive
EVAFLEX P1007: manufactured by Du Pont-Mitsui Polychemicals Co., Ltd., ethylene-vinyl acetate copolymer hot-melt adhesive
ULTRASEN 631: manufactured by Tosho Corp., ethylene-vinyl acetate copolymer hot-melt adhesive
HI-MILAN 1650: manufactured by Du Pont-Mitsui Polychemicals Co., Ltd., ionomer hot-melt adhesive
Scotch-Weld 3748: manufactured by 3M Japan Ltd., polyolefin hot-melt adhesive
Scotch-Weld 3779: manufactured by 3M Japan Ltd., polyamide hot-melt adhesive
MACROMELT 6239: manufactured by Henkel Japan Ltd., polyamide hot-melt adhesive
ALONMELT PES-111EE: manufactured by Toagosei Co., Ltd., polyester hot-melt adhesive
Hi-Bon 4832FA: manufactured by Hitachi Chemical Co., Ltd., polyurethane hot-melt adhesive
HAMATITE M-6209: manufactured by Yokohama Rubber Co., Ltd., rubber hot-melt adhesive
— means that no adhesive layer was provided.

This application claims the priority based on Japanese Patent Application Nos. 2015-188517, 2015-188518, 2015-188519 and 2015-188520 filed on Sep. 25, 2015, Japanese Patent Application Nos. 2015-231528 and 2015-232070 filed on Nov. 27, 2015, Japanese Patent Application No. 2015-249283 filed on Dec. 22, 2015, Japanese Patent Application No. 2016-72336 filed on Mar. 31, 2016, and Japanese Patent Application No. 2016-158117 filed on Aug. 10, 2016, the disclosures of which are incorporated herein in their entirety.

### INDUSTRIAL APPLICABILITY

A decorated molded article produced using the decorative film of the present disclosure is used as an automobile interior part such as a metal-like or piano black-like instrument panel decoration panel, a shift gate panel, a door trim, an air conditioner control panel, or a car navigation, or as an exterior part such as an automobile front or rear emblem, a tire wheel center ornament, or a nameplate. Also, the decorated molded article can be suitably used not only in exterior materials for home electronics, smart keys, smartphones or mobile phones, notebook computers, etc. but in exterior materials for helmets, suitcases, etc., protective sheets which protect liquid crystal display screens of car navigation systems, liquid crystal televisions, etc., exterior materials for electric storage devices, etc., sports goods such as tennis rackets or golf shafts, residential doors or partitions, building materials such as wall materials, and the like, in addition to the automobile interior and exterior parts.

### REFERENCE SIGNS LIST

101 to 108: Decorative film
10: Hard coat layer
1: Base material layer
1a: First base material layer
1b: Second base material layer
2: Adhesive layer
2a: First adhesive layer
2b: Second adhesive layer
3: Colored layer

1. A decorative film comprising
a laminate comprising a hard coat layer and a base material layer,
wherein the decorative film satisfies the following conditions (I) to (VII):
(I) the hard coat layer is a cured product of a thermosetting coating material comprising an acrylic copolymer (A) having hydroxy groups and an isocyanate curing agent (B);
(II) the hard coat layer has a total light transmittance of 40% or more and a diffuse transmittance of 70% or less;
(III) the hard coat layer has a tensile strength of 15 to 100 N/mm² in an atmosphere of 25° C. and 50% RH;
(IV) the acrylic copolymer (A) has
a hydroxy value of 5 to 210 mgKOH/g,
an acid value of 0 to 20 mgKOH/g,
a glass transition temperature of 0 to 95° C.,
a weight-average molecular weight of 100,000 to 1,000,000, and
weight-average molecular weight/number-average molecular weight of 2.3 to 10;
(V) the acrylic copolymer (A) is a copolymer consisting of units derived from monomers having hydroxy group(s) and a unit derived from an additional monomer;
(VI) a content percentage of a unit derived from a monomer having one hydroxy group in 100% by mol of the units derived from monomers having hydroxy group(s) is 50% by mol or more; and
(VII) 56% or more of the hydroxy groups in the acrylic copolymer (A) is a primary hydroxy group.

2. The decorative film according to claim 1, wherein a ratio of the isocyanate groups in the isocyanate curing agent (B) to the hydroxy groups in the acrylic copolymer (A) having hydroxy groups, NCO/OH, in the coating material is 1/1 to 3/1.

3. The decorative film according to claim 1, wherein the base material layer consists of a single layer or multiple layers of a material selected from the group consisting of polyester, polycarbonate, and polymethyl methacrylate.

4. The decorative film according to claim 1, wherein the hard coat layer and the base material layer abut on each other.

5. The decorative film according to claim 1, further comprising at least any one of an adhesive layer and a colored layer.

6. The decorative film according to claim 5, wherein the adhesive layer is laminated between the base material layer and the hard coat layer.

7. The decorative film according to claim 5, wherein the adhesive layer is laminated on a non-facing side of the base material layer with respect to the hard coat layer.

8. A decorated molded article comprising:
a decoratable object; and
a decorative film configured to cover at least a portion of the decoratable object,
wherein the decorative film comprises a laminate comprising a base material layer and a hard coat layer and is a decorative film according to claim 1.

9. A method for producing a decorative film comprising a laminate comprising a hard coat layer and a base material layer, comprising:
providing a thermosetting coating material for forming the hard coat layer, the thermosetting coating material comprising an acrylic copolymer (A) having hydroxy groups and an isocyanate curing agent (B), wherein the hard coat layer which is a cured product of the coating material has a tensile strength of 15 to 100 N/mm² in an atmosphere of 25° C. and 50% RH; and
a step of obtaining a coating layer by coating with the coating material and forming the laminate having a cured coating of the coating layer,
wherein the acrylic copolymer (A) used
is obtained by copolymerizing monomers having hydroxy group(s) with an additional monomer, and
is a polymer configured such that a content percentage of a monomer having one hydroxy group in 100% by mol of the monomers having hydroxy group(s) is 50% by mol or more, 56% or more of the hydroxy groups of the acrylic copolymer (A) is a primary hydroxy group,
a hydroxy value is 5 to 210 mgKOH/g,
an acid value is 0 to 20 mgKOH/g,
a glass transition temperature is 0 to 95° C.,
a weight-average molecular weight is 100,000 to 1,000,000, and
weight-average molecular weight/number-average molecular weight is 2.3 to 10.

10. The method for producing a decorative film according to claim 9, wherein the step of obtaining a coating layer by coating with the coating material and forming the laminate having a cured coating of the coating layer comprises
a step of coating any layer, other than the hard coat layer, constituting the laminate with the coating material.

11. The method for producing a decorative film according to claim 9, wherein the step of obtaining a coating layer by coating with the coating material and forming the laminate having a cured coating of the coating layer comprises
a step of obtaining a coating layer by coating a strippable film with the coating material, obtaining a cured coating of the coating layer, and then joining the cured coating to any layer, other than the hard coat layer, constituting the laminate.
